(19) United States
(12) Patent Application Publication
(10) Pub. No.: US 2019/0199130 A1
(43) Pub. Date: Jun. 27, 2019

(54) ELECTRIC DEVICE, POWER CONSUMPTION REDUCTION SYSTEM, COMMUNICATION ADAPTER, AND POWER CONSUMPTION REDUCTION METHOD

(71) Applicant: Mitsubishi Electric Corporation, Tokyo (JP)

(72) Inventor: Satoshi MINEZAWA, Tokyo (JP)

(73) Assignee: Mitsubishi Electric Corporation, Tokyo (JP)

(21) Appl. No.: 16/313,075

(22) PCT Filed: Aug. 18, 2016
(86) PCT No.: PCT/JP2016/074088

§ 371 Date: Dec. 24, 2018

(51) Int. Cl. H02J 13/00; H02J 3/14; G05B 15/02; F24F 11/46; F24D 19/10; H05B 6/06

(52) U.S. Cl. CPC H02J 13/0006; H02J 3/14; G05B 15/02; H05B 37/0218; F24D 19/1006; H05B 6/06; F24F 11/46

(57) ABSTRACT

In an electrical apparatus, a power consumer consumes power. A request acquirer acquires a request for reducing power consumed by the power consumer. Upon the request acquirer acquiring the request, a power controller controls the power consumer based on at least one of environmental information relating to an ambient environment of the electrical apparatus, apparatus information relating to the electrical apparatus, or time information, to reduce the power.

### CROSS REFERENCE TO RELATED APPLICATION

This application is a U.S. national stage application of International Patent Application No. PCT/JP2016/074088 filed on Aug. 18, 2016, the content of which is incorporated herein by reference.

### TECHNICAL FIELD

The present disclosure relates to an electrical apparatus, a power consumption reduction system, a communication adapter, and a power consumption reduction method.

### BACKGROUND ART

Due to increased awareness of the environment and energy conservation in recent years, technology is known that reduces power consumption of an electrical apparatus.

For example, Patent Literature 1 discloses a power management method that smooths instantaneous peak power by controlling consumption of power consumption systems such as households or offices. Specifically, by the power management method disclosed in Patent Literature 1, power to be consumed by each of at least one group is determined independently of other groups included in the overall system, while complying with constraints on power consumption allocated to the group. Thus power management can be distributed and hierarchized, and structure is simplified.

Further, Patent Literature 2 discloses a power control system that efficiently allocates power consumption of individual power consumption elements while satisfying constraints on total power consumption allocated within a group. Specifically, in the power control system disclosed in Patent Literature 2, a server transmits into a group an adjustment command for total power consumption consumed within the group, which includes at least one power consumption element. Then the at least one power consumption element, on the basis of priority individually given to or determined for the at least one power consumption element by the local element, and on the basis of an adjustment command transmitted from the server, determines an update value of power consumption of the local element independently of, and in parallel with, the server and the power consumption elements other than the local element, and the local element controls the power consumption of the local element.

### PATENT LITERATURE

Patent Literature 1: Unexamined Japanese Patent Application Kokai Publication No. 2015-141482

Patent Literature 2: International Publication No. 2015/115385

In the case in which power consumption is decreased at the electrical apparatus side in accordance with the request from the external device in the aforementioned manner, convenience or comfort of the user may decline when power consumption is reduced in accordance with the request. Thus reduction in power consumption of the electrical apparatus is sought while suppressing the decline in convenience or comfort of the user.

In consideration of the aforementioned circumstances, an objective of the present disclosure is to provide an electrical apparatus and the like capable of decreasing power consumption of the electrical apparatus while suppressing the decline in convenience or comfort of the user.

### SUMMARY

In order to attain the aforementioned objective, the electrical apparatus according to the present disclosure includes:

power consumption means for consuming power;

request acquisition means for acquiring a request for reducing the power consumed by the power consumption means;

power control means for controlling, upon acquisition of the request by the request acquisition means, the power consumption means based on at least one of environmental information regarding an ambient environment of the electrical apparatus, apparatus information regarding the electrical apparatus, or time information, to reduce the power.

According to the present disclosure, upon acquiring the request for reducing the power consumed by the power consumption means, the electrical apparatus controls the power consumption means on the basis of at least one of the environmental information regarding the ambient environment of the electrical apparatus, the apparatus information regarding the electrical apparatus, or the time information, to reduce the power. Thus the present disclosure enables reduction in power consumption of the electrical apparatus while suppressing the decline in convenience or comfort of the user.

### BRIEF DESCRIPTION OF DRAWINGS

FIG. 1 is an overall configuration diagram of a power consumption reduction system according to an embodiment of the present disclosure;

FIG. 2 is a block diagram illustrating hardware configuration of a control device;

FIG. 3 is a block diagram illustrating hardware configuration of an electrical apparatus;

FIG. 4 illustrates functional configuration of the control device and the electrical apparatus;

FIG. 5 illustrates a power consumption distribution in a case in which the electrical apparatus is an air conditioner;

FIG. 6 illustrates a power consumption distribution in a case in which the electrical apparatus is lighting equipment;

FIG. 7 illustrates an example of a control range of power consumption in the case in which the electrical apparatus is the air conditioner;

FIG. 8 illustrates an example of a control range of power consumption in the case in which the electrical apparatus is lighting equipment;

FIG. 9 illustrates an example of a reduction range of power consumption in the case in which the electrical apparatus is the air conditioner;

FIG. 10 illustrates an example of a reduction range of power consumption in the case in which the electrical apparatus is lighting equipment;

FIG. 11 is a first image illustrating a notification example of the control range;

FIG. 12 is a second image illustrating a notification example of the control range;

FIG. 13 is a first image illustrating a notification example of state of the electrical apparatus;

FIG. 14 is a second image illustrating a notification example of the state of the electrical apparatus;

FIG. 15 is a sequence diagram illustrating a summary of processing executed by the power consumption reduction system;

FIG. 16 is a flowchart illustrating control range adjustment processing executed in the case in which the electrical apparatus is the air conditioner;

FIG. 17 is a flowchart illustrating control range adjustment processing executed in the case in which the electrical apparatus is the lighting equipment;

FIG. 18 is a view illustrating a summary of adjustment content of the control range, listed separately according to type of the electrical apparatus; and

FIG. 19 illustrates overall configuration of a power consumption reduction system according to a modified example.

### DESCRIPTION OF EMBODIMENTS

Embodiments of the present disclosure are described below in detail with reference to drawings. In the drawings, components that are the same or equivalent are assigned the same reference sign.

### Embodiment 1

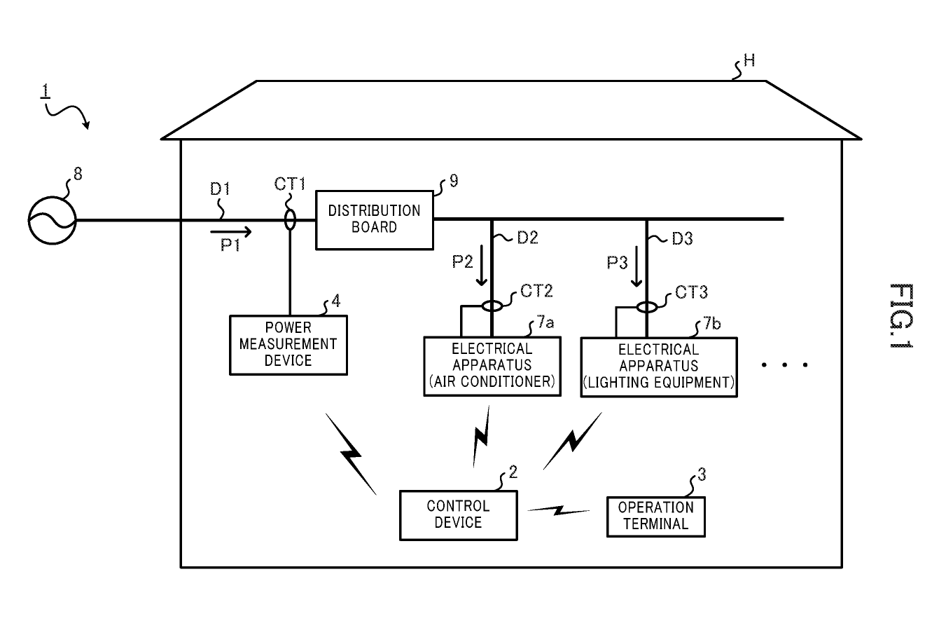

FIG. 1 illustrates overall configuration of a power consumption reduction system 1 according to an embodiment of the present disclosure. This power consumption reduction system 1 is a power management system for management of power used in a general household and is a so-called home energy management system (HEMS). The power consumption reduction system 1 includes a control device 2, an operation terminal 3, a power measurement device 4, and electrical apparatuses 7 (electrical apparatus 7a, 7b, and the like).

The control device 2 is installed in a suitable location within a home H that is a power consumption site, monitors power consumed in the home H (power consumption site), and via the operation terminal 3, displays a state of power consumption. Further, the control device 2 controls operation of, and monitors operational state of, the electrical apparatuses 7 (electrical apparatus 7a, 7b, and the like). Details of the control device 2 are described below.

The operation terminal 3 is a portable device such as a smartphone, a tablet terminal, a remote controller, a portable phone, or a notebook-type personal computer. The operation terminal 3 includes an inputter such as a push button, a touch panel, and a touch pad, a display such as an organic electro-luminescence (EL) display and a liquid crystal display, and a communication interface. The operation terminal 3 performs communication with the control device 2 by a widely-known communication protocol such as Wi-Fi (registered trademark), Wi-SUN (registered trademark), or a wired local area network (LAN). The operation terminal 3 receives an operation by the user and transmits to the control device 2 information indicating received content of the operation. Further, the operation terminal 3 receives information transmitted from the control device 2 to be provided to the user, and displays the received information. In this manner, the operation terminal 3 performs the role of a user interface.

The power measurement device 4 measures a value of power P1 transmitted through a power line D1 arranged between a commercial power system 8 and a distribution board 9. Thus the power measurement device 4 measures the power P1 supplied to the home H from the commercial power system 8. The power measurement device 4 is connected via a communication line to a current transformer (CT) 1 connected to the power line D1. The CT 1 is a sensor that measures alternating current.

The power P1 measured by the power measurement device 4 corresponds to power (purchased power) purchased from the electric utility operator by the consumer consuming power in the home H. In the case in which power generation equipment and power storage equipment are not installed at the home H, this power P1 corresponds to the power (total power consumption) consumed by the entire home H. Thus the power P1 below is also referred to as the purchased power, the total power consumption of the home H, and the like.

The power measurement device 4 includes components (all non-illustrated) such as a central processing unit (CPU), a read only memory (ROM), a random access memory (RAM), a communication interface, and a read-writeable non-volatile semiconductor memory. Further, the power measurement device 4 is equipped with a wireless communication interface and communicates with the control device 2 via a wireless network installed in the home H. The wireless network is a network using, for example, Wi-Fi (registered trademark), infrared communication, or Energy Conservation and Homecare Network Lite (ECHONET Lite). Further, the power measurement device 4 may be configured to connect to this wireless network through a non-illustrated external communication adapter.

The power measurement device 4 generates measurement data containing as measurement values the power P1 transmitted through the power line D1 and obtained by measurement, and transmits the measurement data to the control device 2 periodically in a predetermined cycle. The transmitted measurement data contains data such as a device address of the power measurement device 4, an ID of the power line D1, and a measurement time. Further, in response to a request from the control device 2, the power measurement device 4 may generate the measurement data containing the measurement values of the power line D1 and may transmit the generated data to the control device 2.

The electrical apparatuses 7a, 7b, and the like are installed within the home H (including the grounds thereof), and are apparatuses that consume power in the home H. The apparatuses 7a, 7b, and the like, for example, are home electrical equipment such as an induction heating (IH) cooker, a washing machine, a TV, or a refrigerator, or are facility devices such as an air conditioner, a water heater, lighting equipment, an air circulation fan, power storage equipment, a floor heating system, or a whole-building air conditioning system.

Examples are described below in which the electrical apparatus 7a is an air conditioner, and the electrical apparatus 7b is lighting equipment. However, the electrical apparatuses 7a, 7b, and the like may include types of apparatuses other than the air conditioner and lighting equipment.

The electrical apparatuses 7a, 7b, and the like are connected to power lines D2, D3, and the like branching from the distribution board 9 and operate by power supplied from the commercial power system 8. The electrical apparatus 7a is connected to a CT 2 that is arranged at the power line D2. The electrical apparatus 7a, via the CT 2, acquires a measurement value of power P2 supplied to the electrical apparatus 7a from the distribution board 9. The power P2 corresponds to power consumed by the electrical apparatus 7a. The electrical apparatus 7b is connected to a CT 3 that is arranged at the power line D3. The electrical apparatus 7b, via the CT 3, acquires a measurement value of power P3 supplied to the electrical apparatus 7b from the distribution board 9. The power P3 corresponds to power consumed by the electrical apparatus 7b.

Each of the electrical apparatuses 7a, 7b, and the like is equipped with a wireless communication interface and communicates with the control device 2 via the aforementioned wireless network installed in the home H. Further, each of the electrical apparatuses 7a, 7b, and the like may be configured to be connected to such a wireless network via a non-illustrated external communication adapter. In response to a request from the control device 2, each of the electrical apparatuses 7a, 7b, and the like transmits to the control device 2 via the wireless network, data (operating state data) containing information indicating an apparatus identification (ID), a present time, and a present operating state.

Hereinafter, when the electrical apparatuses 7a, 7b, and the like are being referred to without distinction between the apparatuses, the apparatuses are collectively called the electrical apparatus 7.

The distribution board 9 contains a wiring board that distributes the power P1 supplied from the commercial power system 8 to the electrical apparatuses 7a, 7b, and the like, and contains a breaker that breaks the flow of current during a malfunction.

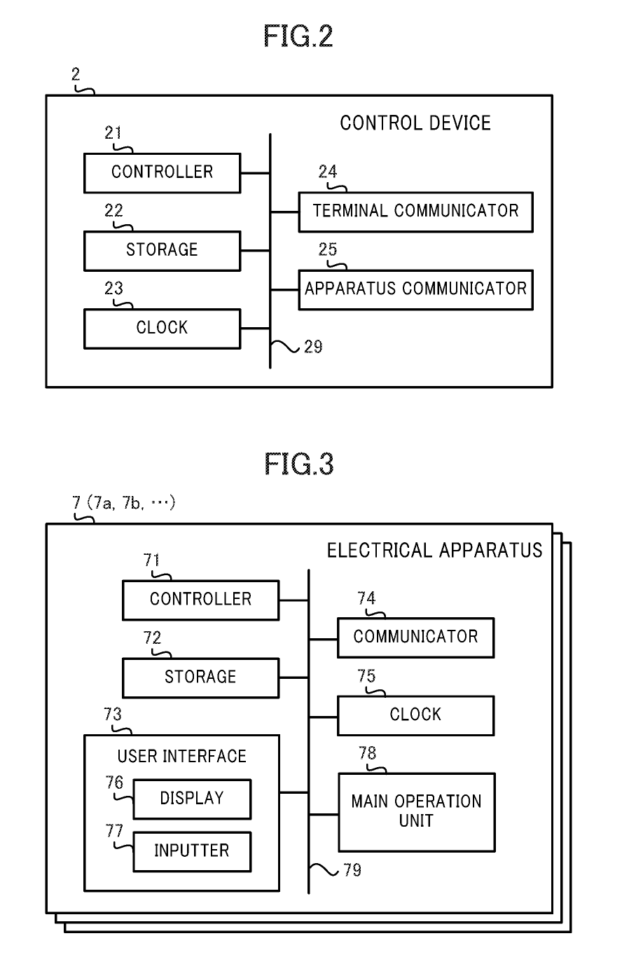

FIG. 2 illustrates a configuration of the control device 2. As illustrated in FIG. 2, the control device 2 includes a controller 21, a storage 22, a clock 23, a terminal communicator 24, and an apparatus communicator 25. These components are connected together via a bus 29.

The controller 21 includes components such as a CPU, ROM, and RAM, although these components are not illustrated. The CPU is also termed a central processing device, a central calculator, a processor, a microprocessor, a microcomputer, a digital signal processor (DSP), or the like. In the controller 21, the CPU reads out programs and data stored in the ROM, and performs integrated control of the control device 2 by using the RAM as a work area.

The storage 22, for example, is non-volatile semiconductor memory such as flash memory, erasable programmable ROM (EPROM), or electrically erasable programmable ROM (EEPROM), and acts as a so-called secondary storage device (supplementary storage device). The storage 22 stores various types of programs and data used by the controller 21 to perform various types of processing, as well as various types of data generated or acquired by the controller 21 performing various types of processing.

The clock 23 is equipped with a real time clock (RTC) that is a clock device to continue measuring time even when power is turned off to the control device 2.

The terminal communicator 24 is provided with a predetermined communication interface, and under control of the controller 21, communicates with the operation terminal 3 via Wi-Fi (registered trademark), Wi-SUN (registered trademark), a wired LAN, or the like. In the case in which a user in possession of the operation terminal 3 is outside the home H, the terminal communicator 24 can communicate with the operation terminal 3 via a wide area network such as the Internet, for example.

The apparatus communicator 25 is equipped with a predetermined communication interface and connects in a communication-capable manner, either wired or wireless, with the aforementioned wireless network installed in the home H. The apparatus communicator 25, under control of the controller 21, communicates with the power measurement device 4 and each of the electrical apparatuses 7 via the wireless network.

FIG. 3 illustrates a configuration of the electrical apparatus 7, that is, the configuration of each of the electrical apparatuses 7a, 7b, and the like. As illustrated in FIG. 3, the electrical apparatus 7 is equipped with a controller 71, a storage 72, a user interface 73, a communicator 74, a clock 75, and a main operation unit 78. These components are connected together via a bus 79.

The controller 71 is equipped with components such as a CPU, a ROM that stores programs and data required for processing by the CPU, and a RAM that functions as a work area of the CPU, and the controller 71 performs integrated control of the electrical apparatus 7.

The storage 72, for example, is non-volatile semiconductor memory such as flash memory, EPROM, or EEPROM, and acts as a so-called secondary storage device (supplementary storage device). The storage 72 stores identification information for identification of this electrical apparatus 7, programs and data for communication with the control device 2, as well as programs and data for control of the main operation unit 78.

The user interface 73 is equipped with components such as a display 76 such as a liquid crystal display (LCD) panel, an organic EL, or a light emitting diode (LED), and an inputter 77 such as a touch panel, touch pad, switches, or various types of pressed buttons. The user interface 73 receives various types of operations from the user via the inputter 77, and displays various types of screen images via the display 76. Further, the display 76 and the inputter 77 may be configured as a touch panel (touch screen) in which these components are superimposed on each other.

The communicator 74 is equipped with a predetermined communication interface. The communicator 74 connects in a communication-capable manner with the wireless network installed in the home H, and under control of the controller 71, communicates with the control device 2 via the wireless network.

The clock 75 is equipped with a RTC and is a clock device that continues measuring time even when power is turned off to the electrical apparatus 7.

The main operation unit 78 is a constituent part for achievement of a fundamental function of the electrical apparatus 7. For example, the electrical apparatus 7a, which is the air conditioner, is equipped with, as the main operation unit 78, components such as an indoor unit, an outdoor unit, a blower, and a heat pump. The electrical apparatus 7b, which is the lighting equipment, is equipped with, as the main operation unit 78, an LED and a drive circuit for causing lighting of the LED. Alternatively, in the case in which the electrical apparatus 7 is the water heater, the electrical apparatus 7 is equipped with, as the main operation unit 78, a hot water storage tank, a heat source unit, a heat pump, and the like. The main operation unit 78 is equipped with a drive mechanism for achieving the functions of the electrical apparatus 7 in this manner.

Further, an apparatus main body of the electrical apparatus 7, depending on the apparatus type, may be equipped with the user interface 73 (the display 76 and the inputter 77), or alternatively, without equipping the apparatus main body with the user interface 73, a remote controller separated from the apparatus main body may function as the user interface 73. In this case, the electrical apparatus 7 communicates with the remote controller via the communicator 74. The communicator 74 transmits signals indicating display content for display by the display 76 of the remote controller and receives a signal indicating content of operations received by the inputter 77 of the remote controller from the user.

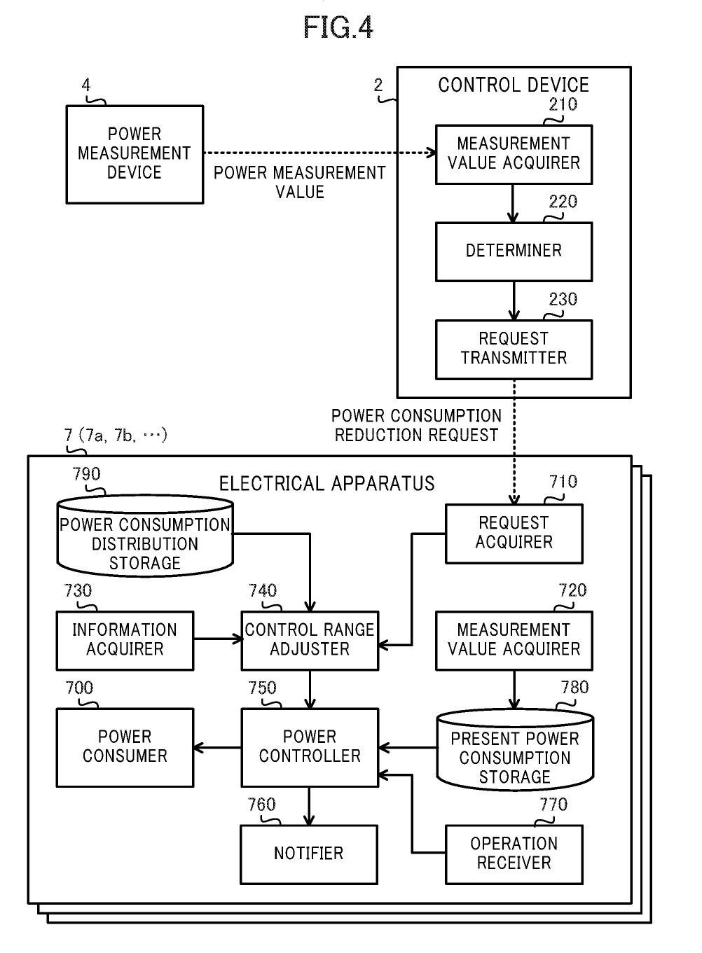

Functional configurations of the control device 2 and the electrical apparatus 7 are described next with reference to FIG. 4. The control device 2 is functionally equipped with a measurement value acquirer 210, a determiner 220, and a request transmitter 230. Each of these functions is achieved by software, firmware, or a combination of software and firmware. The software and the firmware are recorded as programs and are stored in a ROM or the storage 22. Further, by the CPU executing programs stored in the ROM or the storage 22, the controller 21 achieves the functions of various components.

The measurement value acquirer 210 acquires the measurement value of the power P1 supplied from the commercial power system 8 to the home H that is the power consumption site where the electrical apparatuses 7a, 7b, and the like are installed. The power P1, which is the power obtained by measurement by the power measurement device 4 in the aforementioned manner, is supplied from the commercial power system 8 to the home H and corresponds to power purchased from the commercial power system 8 or the total power consumption of the home H. The measurement value acquirer 210 acquires from the power measurement device 4 via the apparatus communicator 25 the measurement value of the power P1 obtained by the power measurement device 4. The measurement value acquirer 210 is achieved by the controller 21 in cooperation with the apparatus communicator 25.

The power measurement device 4 periodically in a predetermined cycle transmits to the control device 2 the measurement value, obtained by the CT 1, of the power P1 transmitted through the power line D1. The predetermined cycle, for example, is 10 seconds to several tens of seconds. Alternatively, the measurement value acquirer 210 periodically in a predetermined cycle may transmit to the power measurement device 4 a request for the measurement value of the power P1, and the power measurement device 4 may, in responding to the request, transmit to the control device 2 the measurement value of the power P1.

The determiner 220 determines whether the measurement value acquired by the measurement value acquirer 210 is greater than or equal to a predetermined permissible value. This permissible value is an upper limit of electrical energy permitted to be purchased from the commercial power system 8 at the present time, that is, this permissible value is an upper limit of the electrical energy permitted to be consumed within the home H.

Specifically, the determiner 220 sets the permissible value on the basis of electricity cost. More specifically, the determiner 220, so that the electricity cost does not exceed the upper limit value, sets the permissible value to a smaller value in a time slot having a high unit electricity cost, and sets the permissible value to a larger value in a time slot having a low unit electricity cost. Further, when a request is received from the commercial power system 8 to limit the amount of purchased power as in the case of a demand response event, for example, the determiner 220 sets the permissible value to a value in response to the received request. Further, in the case in which the permissible value is inputted by the user operating the operation terminal 3, the determiner 220 acquires from the operation terminal 3 the inputted received value via the terminal communicator 24, and sets the permissible value to the inputted received value. The determiner 220 stores in the storage 22 the permissible value set in this manner.

Every time the measurement value acquirer 210 performs acquisition from the power measurement device 4, the determiner 220 compares the measurement value of the power P1 to the permissible value. Then the determiner 220 outputs to the request transmitter 230 a determination result indicated whether the measurement value is equal to or greater than the permissible value. The determiner 220 is achieved by the controller 21 in cooperation with the storage 22.

In the case in which the measurement value acquired by the measurement value acquirer 210 is greater than or equal to the permissible value, the request transmitter 230 transmits to each of the electrical apparatuses 7a, 7b, and the like a request (referred to hereinafter as the “reduction request”) requesting a reduction in the power consumption of each of the electrical apparatuses 7a, 7b, and the like. The “reduction request” is a request for reduction of power consumption of the electrical apparatuses 7 by changing the operating state of, or by stopping operation of, the electrical apparatuses 7 that are presently operating.

In the case of the result of the determination by the determiner 220 being that the measurement value is less than the permissible value, the request transmitter 230 does not transmit the reduction request to every electrical apparatus 7. In contrast, in the case in which the result of determination by the determiner 220 is that the measurement value is greater than or equal to the permissible value, the request transmitter 230 transmits the reduction request via the apparatus communicator 25 to each of the electrical apparatuses 7a, 7b, and the like. At this time, the request transmitter 230 transmits the reduction request by a communication method such as multicasting, broadcasting, or the like. The request transmitter 230 is achieved by the controller 21 in cooperation with the apparatus communicator 25.

More specifically, the request transmitter 230 transmits to each of the electrical apparatuses 7a, 7b, and the like the reduction request indicating a command amount (reduction command amount) of power consumption to be reduced. In the case in which the measurement value of the power P1 acquired by the measurement value acquirer 210 is in excess of the permissible value, the request transmitter 230 in response calculates a reduction command amount overall for the electrical apparatuses 7a, 7b, and the like. Then the request transmitter 230 transmits the reduction request indicating the calculated reduction command amount to each of the electrical apparatuses 7a, 7b, and the like.

Further, the request transmitter 230 may calculate the reduction command amount individually for each of the electrical apparatuses 7a, 7b, and the like, and may transmit the calculated individual reduction command amount to the respective electrical apparatus 7a, 7b, and the like. In this case, the request transmitter 230 calculates the individual reduction command amounts by equally dividing the overall reduction command amount for the electrical apparatuses 7a, 7b, and the like among the separate electrical apparatuses 7, or by weighted allocation in accordance with the type of the electrical apparatus 7.

Functional configuration of the electrical apparatus 7 is described next. As illustrated in FIG. 4, each of the electrical apparatuses 7a, 7b, and the like is functionally equipped with a request acquirer 710, a measurement value acquirer 720, an information acquirer 730, a control range adjuster 740, a power controller 750, a notifier 760, and an operation receiver 770. Each of these functions is achieved by software, firmware, or a combination of software and firmware. The software and firmware are recorded as programs and are stored in the ROM or the storage 72. The controller 71 achieves each of the functions by the CPU executing programs stored in the ROM or the storage 72.

Further, each of the electrical apparatuses 7a, 7b, and the like is equipped with a present power consumption storage 780, a power consumption distribution storage 790, and a power consumer 700. The present power consumption storage 780 and the power consumption distribution storage 790 are configured as memory regions of the storage 72.

The power consumer 700 is a constituent component that consumes power. The power consumer 700 is equipped with a drive mechanism for achieving the inherent function of the electrical apparatus 7. Specifically, the main operation unit 78 functions as the power consumer 700. The power consumer 700 consumes a majority of power among the overall power consumption of the electrical apparatus 7. Thus the “power consumed by the power consumer 700” is used hereinafter nearly synonymously with the “power consumption of the electrical apparatus 7”.

The request acquirer 710 acquires a request for reducing the power consumed by the power consumer 700. This request is a reduction request transmitted to each of the electrical apparatuses 7a, 7b, and the like by the request transmitter 230 of the control device 2. The request acquirer 710 receives, via the communicator 74 and the wireless network installed in the home H, the reduction request transmitted from the control device 2. The request acquirer 710 is achieved by the controller 71 in cooperation with the communicator 74.

The measurement value acquirer 720 acquires the measurement value of power consumed by the electrical apparatus 7. The power consumption of the electrical apparatus 7a, 7b, and the like corresponds respectively to the power P2, P3, and the like supplied from the distribution board 9 to the electrical apparatus 7a, 7b, and the like through the power lines D2, D3, and the like. Specifically, the measurement value acquirer 720 of the electrical apparatus 7a, via the communicator 74, communicates with the CT 2 arranged at the power line D2, and acquires the measurement value of the power P2 measured by the CT 2. Further, the measurement value acquirer 720 of the electrical apparatus 7b, via the communicator 74, communicates with the CT 3 arranged at the power line D3, and acquires the measurement value of the power P3 measured by the CT 3. The measurement value acquirer 720 is achieved by the controller 71 in cooperation with the communicator 74.

The present power consumption storage 780 stores the present power consumption of the electrical apparatus 7. The present power consumption is the power that the electrical apparatus 7 is presently consuming. The present power consumption differs in accordance with the operating state of the electrical apparatus 7 and is substantially zero when the electrical apparatus 7 is not running.

The present power consumption storage 780 stores the measurement value of power acquired by the measurement value acquirer 720 as the present power consumption of the electrical apparatus 7. The measurement value acquirer 720, repeatedly in a predetermined cycle, acquires the measurement value of the power acquired by the measurement value acquirer 720. The measurement value acquirer 720, for each new acquisition of the measurement value of the power consumption of the local apparatus, causes storage of the newly acquired measurement value as the present power consumption in the present power consumption storage 780.

The power consumption distribution storage 790 stores the power consumption distribution of the electrical apparatus 7. The term “power consumption distribution” means a distribution representing, for each operation mode and control content of the electrical apparatus 7, the power consumed by the electrical apparatus 7. The electrical apparatus 7, in the case in which the local apparatus operates in various types of operation modes and by various types of control content, generates the power consumption distribution by using the measurement value acquirer 720 to acquire the measurement value of the power consumption. Then the generated power consumption distribution is stored in the power consumption distribution storage 790.

FIG. 5 illustrates an example of the power consumption distribution of the electrical apparatus 7a that is the air conditioner. The power consumption distribution of FIG. 5 discontinuously represents power consumption occurring in the cases of operation of the electrical apparatus 7a in each of the operation modes that are heating, cooling, humidifying, dehumidifying, and air circulating. As illustrated in FIG. 5, the electrical apparatus 7a consumes relatively high power when cooling and heating, and consumes relatively low power when humidifying, dehumidifying, and air circulating.

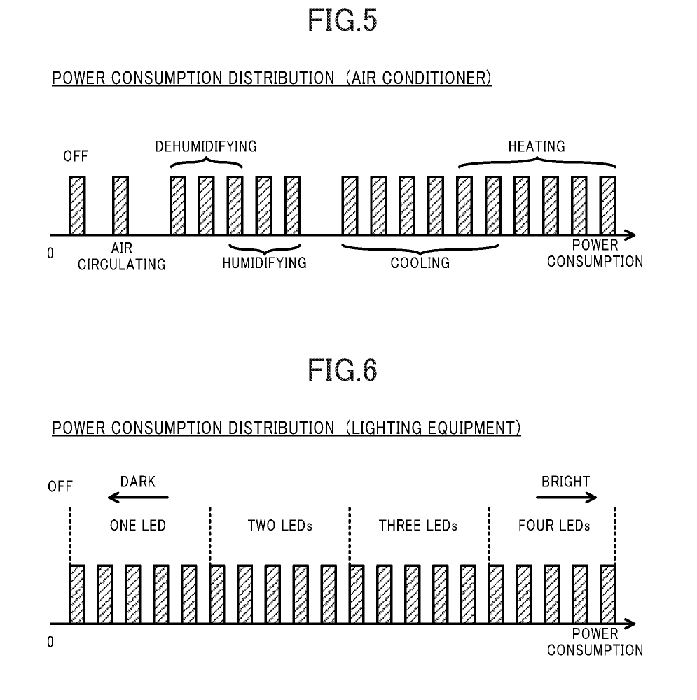

FIG. 6 illustrates an example of the power consumption distribution of the electrical apparatus 7b that is the lighting equipment. The power consumption distribution of FIG. 6 discontinuously represents power consumption of operation of the electrical apparatus 7b in the case of a single LED of the electrical apparatus 7b being lit through the case of four LEDs of the electrical apparatus 7b being lit. As illustrated in FIG. 6, the electrical apparatus 7b consumes more power as more LEDs are used and illuminance increases.

The power consumption distribution storage 790 stores the power consumption distribution in this manner similarly for the electrical apparatuses 7 that are neither the air conditioner nor the lighting equipment. Further, some electrical apparatuses 7 may be unable to measure the power consumption of the local apparatus, and thus low accuracy in the power consumption distribution is permissible.

The information acquirer 730 acquires at least one of environmental information relating to the environment around the local apparatus, apparatus information relating to the local apparatus, or time information. The “environmental information” is information related to the location, and the ambient environment, at the outside of the electrical apparatus 7 where the electrical apparatus 7 is installed. The environmental information is information independent of the electrical apparatus 7 itself. Cited examples of the environmental information include a room temperature, an outdoor air temperature, a humidity, an illuminance, a sound volume, a presence of persons, and a presence of pets. The “apparatus information” is information related to the electrical apparatus 7, such as an operating state of the electrical apparatus 7 or information about the interior of the electrical apparatus 7. Cited examples of the apparatus information include a remaining hot water amount in the case in which the electrical apparatus 7 is a water heater, an interior temperature and an interior illuminance in the case in which the electrical apparatus 7 is a refrigerator, and a charge amount in the case in which the electrical apparatus 7 is a power storage device. The “time information” is information related to the time. Cited examples of the time information include a time, a season, and a schedule.

The information acquirer 730 acquires the environmental information via the communicator 74 from the sensor (none of which are illustrated) that senses the environmental information such as the temperature sensor sensing room temperature or outside air temperature, the humidity sensor sensing the humidity, the illuminance sensor sensing illuminance, the sound volume sensor sensing the sound volume, or an infrared sensor sensing the presence of humans or pets. The information acquirer 730 acquires the apparatus information from the sensor that is installed within the local apparatus and that senses the remaining hot water amount, the charge amount, or the like. The information acquirer 730 acquires the time information by acquiring the present date-time from the clock 75. The information acquirer 730 is achieved by the controller 71 in cooperation with the communicator 74, the clock 75, and the like.

The control range adjuster 740 adjusts the control range of power consumed by the power consumer 700 on the basis of at least one of the environmental information, the apparatus information, or the time information acquired by the information acquirer 730. The “control range” is the permissible range of the power consumption of the electrical apparatus 7 that enables suppression of unnecessary waste of power, while suppressing decrease in the convenience and comfort of the user. The power capable of being consumed by the electrical apparatus 7 is limited to be within the control range adjusted by the control range adjuster 740. That is, in order to suppress unnecessary waste of power, the electrical apparatus 7 cannot operate at a power consumption larger an upper limit of the control range. Further, in order to suppress lowering of convenience and comfort of the user, the electrical apparatus 7 cannot operate (including stoppage of running) at a power consumption smaller than a lower limit of the control range.

The control range adjuster 740 refers to the power consumption distribution stored in the power consumption distribution storage 790 and adjusts the control range of the power consumption. The control ranges of power consumption of the electrical apparatus 7a that is the air conditioner and the electrical apparatus 7b that is the lighting equipment are described below.

Case of Air Conditioner as the Electrical Apparatus 7

When the electrical apparatus 7a is the air conditioner, the control range adjuster 740, in the case in which the present season is summer, does not include in the control range the power consumed by the power consumer 700 during a heating operation, and in the case in which the present season is winter, does not include in the control range the power consumed by the power consumer 700 during a cooling operation. Such operation is used since heating is normally considered to be unnecessary in summer and cooling is normally considered to be unnecessary in winter. In the case in which the present season is summer, by adjustment of the control range so as not to include the power consumption that occurs during the heating operation, the air conditioner is made incapable of shifting the operation mode to heating. In the same manner, in the case in which the present season is winter, by adjustment of the control range so as not to include the power consumption that occurs during the cooling operation, the air conditioner is made incapable of shifting the operation mode to cooling. Thus heating does not occur in summer and cooling does not occur in winter, and unnecessary power consumption can be suppressed. Further, whether the present season is winter or summer can be determined by the time information acquired by the information acquirer 730.

The control range adjuster 740 of the electrical apparatus 7a, in the case in which the ambient temperature of the electrical apparatus 7a is higher than a first reference temperature, does not include in the control range the power consumed by the power consumer 700 during the heating operation, and in the case in which the ambient temperature of the electrical apparatus 7a is lower than a second reference temperature, does not include in the control range the power consumed by the power consumer 700 during the cooling operation. Such operation is used since heating is normally considered to be unnecessary when the temperature is high, and since cooling is normally considered to be unnecessary when the temperature is low. The first reference temperature is set to a temperature at which heating is determined not to be required, such as 30° C. or 40° C. The second reference temperature is set to a temperature at which cooling is determined not to be required, such as 0° C. or 10° C. The ambient temperature of the electrical apparatus 7a may be the temperature within a room in which the electrical apparatus 7a is installed, or may be an outdoor air temperature. The temperature of the indoor or outdoor air is acquired as the environmental information by the information acquirer 730. The other parameters are set similarly to the aforementioned case in which the season is summer or winter.

The control range adjuster 740 of the electrical apparatus 7a, in the case in which the ambient humidity of the electrical apparatus 7a is higher than a first reference humidity, does not include the in the control range power consumed by the power consumer 700 during the humidifying operation, and in the case in which the ambient humidity of the electrical apparatus 7a is lower than a second reference humidity, does not include the in the control range power consumed by the power consumer 700 during the dehumidifying operation. Such operation is used since humidifying is considered to normally be unnecessary when the humidity is high, and dehumidifying is considered to normally be unnecessary when the humidity is low. The first reference humidity, for example, is 80% or 90%, and is set to a humidity for which humidifying is determined to not be required. The second reference humidity, for example, is 20% or 30%, and is set to a humidity for which dehumidifying is determined to not be required. The ambient humidity of the electrical apparatus 7a may be the humidity of the room in which the electrical apparatus 7a is installed, or may be the humidity of the outside air. The indoor humidity or the outdoor humidity is acquired as the environmental information by the information acquirer 730. The other parameters are set similarly to the above case of using the temperature as the reference.

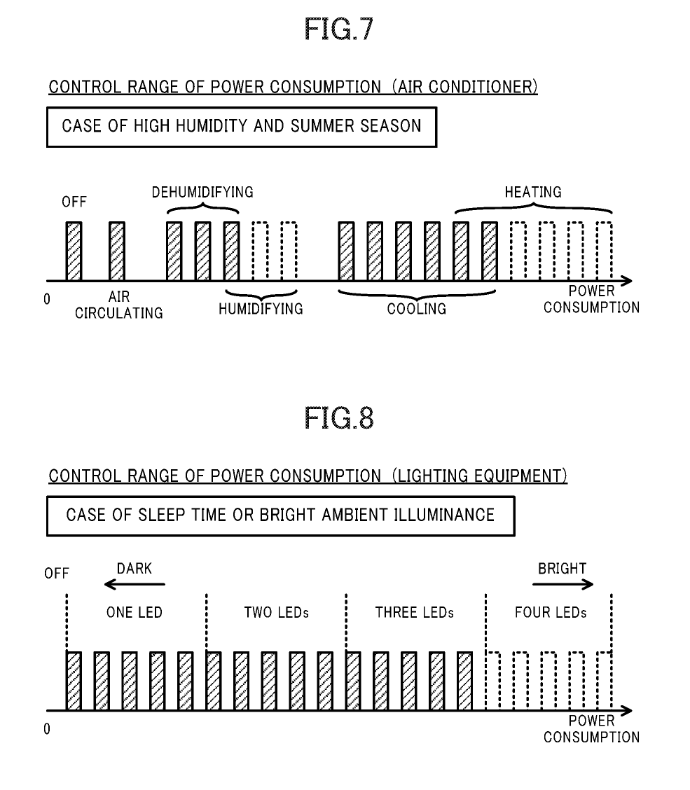

FIG. 7 illustrates an example of the control range when the present season is summer and the humidity is higher than the first reference humidity. Due to the present season being summer, the control range adjuster 740 deletes from the controllable overall range the range of power consumption during the heating operation. Further, due to high humidity, the control range adjuster 740 deletes from the controllable overall range the range of power consumption during the humidifying operation. In FIG. 7, the range deleted from the power consumption distribution is indicated by dashed lines. That is to say, the control range adjuster 740 deletes the power consumed only during the heating operation time and the humidifying operation time, does not delete the power consumption during which the heating operation time and the cooling operation time overlap, and does not delete the power consumption during which the humidifying operation time and the dehumidifying operation time overlap. Due to such operation, the operation mode capable of execution by the electrical apparatus 7a is limited to the range indicated by hatching in FIG. 7, that is, is limited to cooling, dehumidifying, or air circulating.

Further, in the case in which the temperature is relatively cool even in summer, strong cooling is not required. Thus in the case in which the present season is summer and the ambient temperature is lower than the second reference temperature, the control range adjuster 740 lowers the upper limit of the control range during cooling to below the upper limit of the control range in the case when the present season is summer and the ambient temperature is higher than the second reference temperature. Such operation suppresses excess lowering of the setting temperature of cooling. Further, in the case in which the temperature is relatively high even in winter, strong heating is not required. Thus in the case in which the present season is winter and the ambient temperature is higher than the first reference temperature, the control range adjuster 740 lowers the upper limit of the control range during heating to below the upper limit of the control range in the case when the present season is winter and the ambient temperature is lower than the first reference temperature. Such operation suppresses excess increase of the setting temperature of heating.

Further, in the case in which a person is present in the room in which the electrical apparatus 7a is installed, in comparison to the case in which a person is not present in the room, the control range adjuster 740 reduces the reduction amount of the power consumption in order to maintain human comfort indoors. Specifically, in the case in which a person is present in the room, the control range adjuster 740 reduces the reduction amount, by more than the amount per the reduction request, by multiplying, by a coefficient less than one, the reduction amount of the power consumption determined in accordance with the reduction request acquired by the request acquirer 710. Due to such operation, when a person is not present in the room in which the electrical apparatus 7a is installed, the power controller 750 reduces the power consumed by the power consumer 700 greater than when a person is present in the room. The presence of a person within the room can be determined by sensing information of an infrared sensor acquired as environmental information by the information acquirer 730.

Further, in the case in which a pet is present in the room in which the electrical apparatus 7a is installed, in order not to stop operation of the air conditioner, the control range adjuster 740 deletes the range of power consumption of the time of stoppage (that is, the region near zero) from the controllable overall range. Due to such operation, air conditioning does not stop while the pet is in the room, and thus comfort and safety of the pet can be increased. Further, distinction as to whether a human or a pet is present in the room is possible on the basis of size, height, or the like of the object sensed by the infrared sensor.

Case of Lighting Equipment as the Electrical Apparatus 7

In the case in which the present time is included in a predetermined sleep period, the control range adjuster 740 of the electrical apparatus 7b that is the lighting equipment lowers the upper range of the control range in comparison to the case in which the present time is not included in the sleep period. Such operation is used due to a lack of a requirement for making the room interior bright in the sleep period. Conversely, convenience and comfort of the user decrease when the room interior is darkened during the non-sleep period. Thus when the present time is not included in the sleep period, the control range adjuster 740 raises the lower limit of the control range in comparison to the case in which the present time is included in the sleep period. The sleep period can be set depending on the user, and is a time slot such as 9 pm to 6 am, or 11 pm to 8 am. Whether the present time is included in the sleep period can be determined in accordance with the time information acquired by the information acquirer 730.

In the same manner, in the case in which ambient illuminance of the electrical apparatus 7b is larger than a reference illuminance, the control range adjuster 740 of the electrical apparatus 7b lowers the upper limit of the control range in comparison to the case in which the ambient illuminance of the electrical apparatus 7b is smaller than the reference illuminance Such operation is used due to low necessity of brightening the room interior by the lighting equipment when the surroundings are bright, such as at noon and during clear weather. Conversely, convenience and comfort of the user are decreased if illumination is lowered when ambient illuminance is low. Thus in the case in which the ambient illuminance is lower than the reference illuminance, the control range adjuster 740 raises the lower limit of the control range in comparison to the case in which the ambient illuminance is greater than the reference illuminance. The “ambient illuminance” of the electrical apparatus 7b is the illuminance due to light from the outside minus illuminance due to the electrical apparatus 7b itself, that is, is the illuminance in the case in which the electrical apparatus 7b is unlit. The ambient illuminance of the electrical apparatus 7b is acquired as the environmental information by the information acquirer 730. The reference illuminance is set beforehand in accordance with user preference. The other parameters are set similarly to the case of the sleep period.

FIG. 8 illustrates an example of the control range in the case in which the present time is included in the sleep period, or the ambient illuminance of the electrical apparatus 7b is brighter than the reference illuminance. In the case of the sleep period or bright surroundings, greatly increasing illuminance is not required, and thus the control range adjuster 740 deletes from the controllable overall range the range of power consumption of the case in which four LEDs are lit. Thus the control range adjuster 740 decreases the upper limit of the control range to the power consumption in the case in which three LEDs are lit. In FIG. 8, the range deleted from the power consumption distribution is indicated by dashed lines. Due to such operation, the electrical apparatus 7b that is the lighting equipment is limited to the range indicated by hatching in FIG. 8, that is, is limited to the range in which at most three LEDs are lit.

Further, in the case in which a person is present in the room in which the electrical apparatus 7b is arranged, in order to maintain comfort for the person present in the room, the control range adjuster 740 decreases the reduction amount of the power consumption in comparison to the case in which the person is not present in the room. Thus when a person is not present within the room in which the electrical apparatus 7b is arranged, the power controller 750 reduces the power consumed by the power consumer 700 greater than when the person is present in the room. Details of such processing are similar to details in the aforementioned case in which the electrical apparatus 7a is the air conditioner.

The control range adjuster 740 executes such adjustment processing of the control range in the case of the operation receiver 770 receiving an operation by the user after the request acquirer 710 acquires the reduction request from the control device 2, or in the case in which a predetermined period elapses. The “operation by the user” specifically is an operation to command start of running the electrical apparatus 7, change of the operating state, or the like, and the operation by the user is received via the inputter 77 of the user interface 73 or the operation terminal 3. The “predetermined period” is a window period, such as 15 minutes or 30 minutes, until an update of the operating state of the electrical apparatus 7. In this manner, by setting a period for the control range adjuster 740 to adjust the control range after the request acquirer 710 acquires the reduction request, due to elimination of rapid change in the present state of the electrical apparatus 7, lowering of user comfort can be suppressed.

The functional configuration of the electrical apparatus 7 illustrated in FIG. 4 is further described. In the case in which the request acquirer 710 acquires the reduction request from the control device 2, the power controller 750 controls the power consumer 700 on the basis of at least one of the environmental information, the apparatus information, or the time information acquired by the information acquirer 730, to reduce the power consumed by the power consumer 700.

The expression “controlling the power consumer 700” means controlling the main operation unit 78 that is the main constituent unit of the electrical apparatus 7, and thus changing the operating state of the electrical apparatus 7 that is the operation mode (cooling, heating, dehumidifying, humidifying, air circulating, or the like) or the operation capability (setting temperature, setting humidity, setting illuminance, or the like). For example, the power controller 750 of the electrical apparatus 7a that is the air conditioner reduces the power consumption by controlling the heat pump, the blower, and the like to decrease the capacity for cooling, heating, dehumidifying, humidifying, or air circulating. Further, the power controller 750 of the electrical apparatus 7b that is the lighting equipment controls the drive circuit of the LEDs and decreases illuminance, thereby reducing the power consumption. The power controller 750 is achieved by the controller 71 in cooperation with the storage 72, the main operation unit 78, and the like.

The power controller 750 determines the reduction amount of the power consumption in accordance with the reduction request acquired by the request acquirer 710. Specifically, in the case in which a reduction command amount is indicated in the reduction request for the overall electrical apparatuses 7a, 7b, and the like, the power controller 750 determines as the reduction amount an amount smaller than the reduction command amount by multiplying the reduction command amount by a predetermined ratio. However, in the case in which a reduction command amount is indicated separately for the local apparatus in the reduction range request, the power controller 750 determines the reduction amount to be the reduction command amount as is.

In the case in which the request acquirer 710 acquires the reduction request from the control device 2, the power controller 750 reduces the power consumed by the power consumer 700 to be within the control range adjusted by the control range adjuster 740. Specifically, the power controller 750 refers to the present power consumption stored in the present power consumption storage 780, and determines whether the power, obtained by reducing by the reduction amount determined in accordance with the reduction request from the present power consumption of the power consumer 700, is contained within the control range. In the case in which the result of the determination is that the power that is obtained by reducing by the aforementioned reduction amount from the present power consumption is within the control range, the power controller 750 cuts the power of the aforementioned reduction amount from the power consumed by the power consumer 700. That is, the power controller 750 cuts the power consumed by the power consumer 700 by a power amount in accordance with the request from the control device 2.

In contrast, when the power that is obtained by reducing by the aforementioned reduction amount from the present power consumption is not within the control range, the power controller 750 cuts the power consumed by the power consumer 700 to be within the control range. That is, the power controller 750 does not cut the power consumption per the request from the control device 2.

Specifically, when the power that is obtained by reducing by the aforementioned reduction amount from the present power consumption is larger than the upper limit of the control range, the power that cuts the power consumption as per the request is needlessly wasteful. Thus in this case, the power controller 750 reduces the power consumed by the power consumer 700 to the power of the upper limit of the control range. However, in the case in which the power that is obtained by reducing by the aforementioned reduction amount from the present power consumption is smaller than the lower limit of the control range, user convenience and comfort decline when power consumption is reduced per the request. Thus in this case, the power controller 750 reduces the power consumed by the power consumer 700 to the power of the lower limit of the control range.

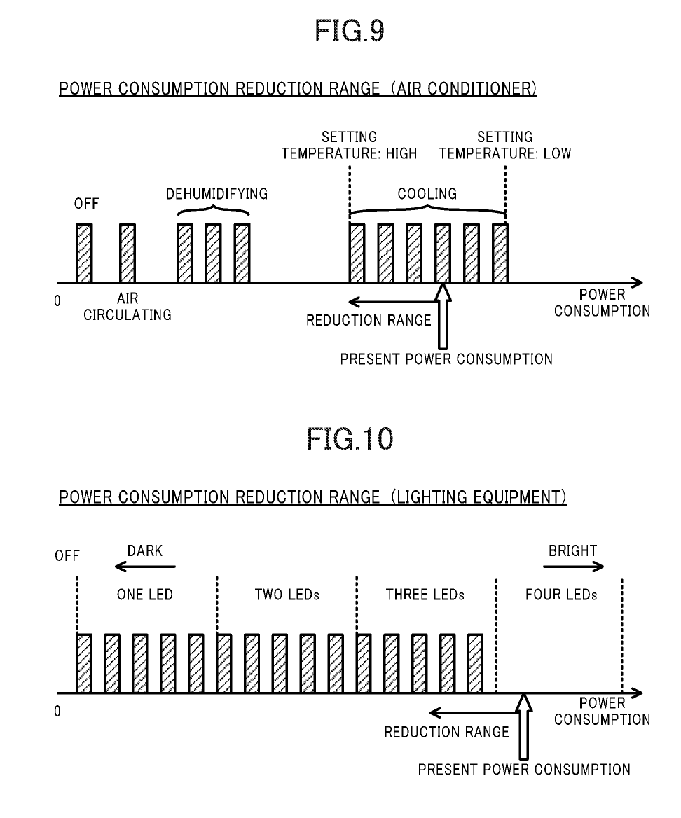

FIG. 9 illustrates an example of the reduction range of the power consumption of the electrical apparatus 7a that is the air conditioner. The example of FIG. 9 illustrates a case in which, during the cooling operation of the electrical apparatus 7a, the control range is restricted to at least one of cooling, dehumidifying, or air circulating. In this case, upon the request acquirer 710 acquiring the reduction request, the power controller 750 reduces the power consumption to within the control range by raising the setting temperature of cooling and lessening the cooling, or alternatively, by changing the operation mode to at least one of dehumidifying, air circulating, or operation stoppage. In the case in which operation is in an operation mode other than cooling, similarly the power controller 750 reduces the power consumption to within the control range by lowering capacity or by change of the operation mode.

FIG. 10 illustrates an example of the reduction range of power consumption of the electrical apparatus 7b that is the lighting equipment. In the example of FIG. 10, a case is illustrated in which, when the electrical apparatus 7b has four lit LEDs, the control range is limited to a count of lighting-capable LEDs that is less than or equal to three. In this case, when the request acquirer 710 acquires the reduction request, the power controller 750 reduces the power consumption to within the control range by lowering the illuminance.

In this manner, when the request acquirer 710 acquires the reduction request from the control device 2 while the electrical apparatus 7 is running, the power controller 750 reduces the power consumed by the power consumer 700 to power within the control range adjusted on the basis of the environmental information, the apparatus information, or the time information. Further, in the case in which the electrical apparatus 7 is consuming substantially no power, such as when the electrical apparatus 7 is not running, the power controller 750 does not lower power even though the request acquirer 710 acquires the reduction request.

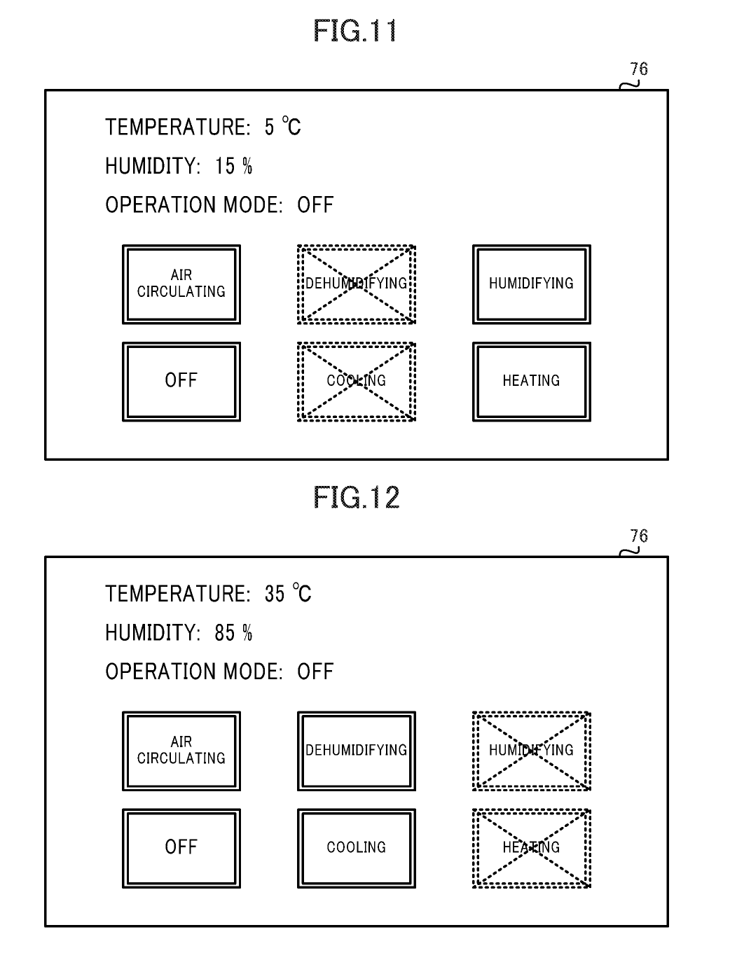

The notifier 760 provides notification of the control range adjusted by the control range adjuster 740 and the content of control by the power controller 750. With reference to FIGS. 11 to 14, an example of notification by the notifier 760 is described in the case in which the electrical apparatus 7a is the air conditioner.

In the case in which the control range adjuster 740 adjusts the control range of the power consumption and the power controller 750 reduces the power consumption to be within the control range, the notifier 760 provides notification distinguishing between user-selectable operations and user-non-selectable operations. A user-selectable operation and a user-non-selectable operation are determined in accordance with the control range after adjustment by the control range adjuster 740. Specifically, the notifier 760 displays on the display 76 of the user interface 73 notification images shown in FIGS. 11 and 12. As illustrated in FIGS. 11 and 12, the display 76 displays buttons labeled “heating”, “cooling”, “humidifying”, “dehumidifying”, air circulating”, and “OFF” as a user-selectable operation mode. The display 76 is overlapped by the inputter 77, and the user can select and input the operation mode of the air conditioner by touching the desired button.

In the case in which both the ambient temperature and the ambient humidity are lower than reference values so that the power consumption occurring during the cooling operation and the dehumidifying operation is deleted from the control range, as illustrated in FIG. 11, the notifier 760 displays on the display 76 that the “cooling” and “dehumidifying” operation modes are forbidden and non-selectable. In contrast, in the case in which the ambient temperature and the ambient humidity are both higher than reference values so that the power consumption occurring during the heating operation and the humidifying operation is deleted from the control range, as illustrated in FIG. 12, the notifier 760 indicates on the display 76 that the “heating” and “humidifying” operation modes are forbidden and non-selectable. Due to such operation, the user can understand which operation modes are selectable. Further, the user can be prohibited from operations outside of the control range.

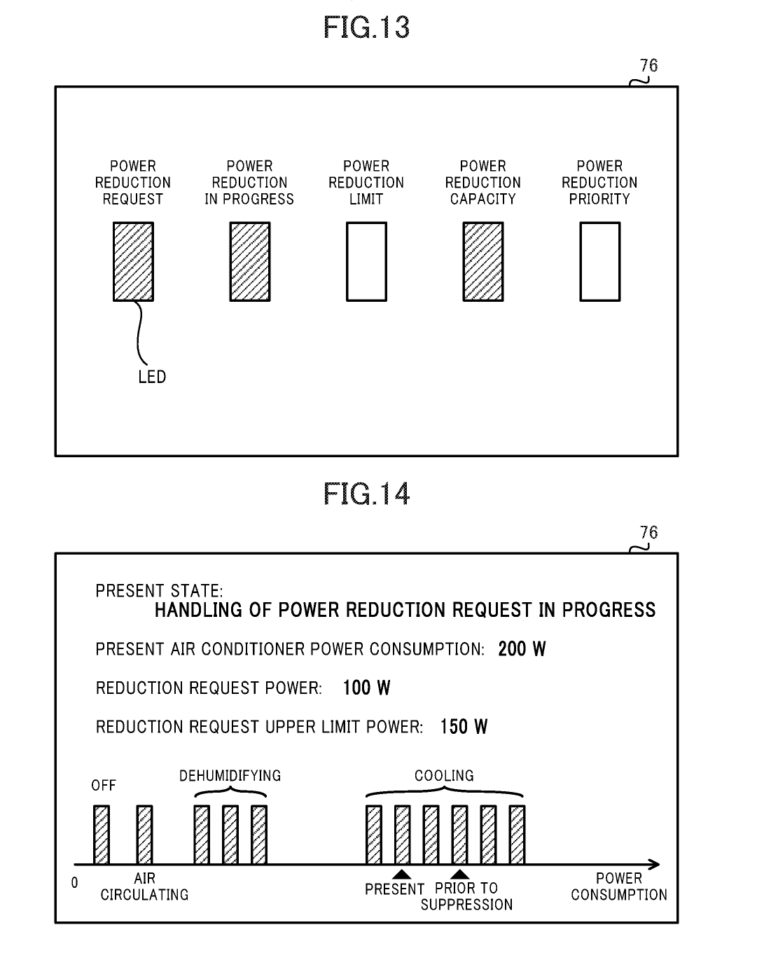

Further, in order to provide notification of the control content of the power controller 750, the notifier 760 displays on the display 76 of the user interface 73 the notification images illustrated in FIGS. 13 and 14. As illustrated in FIG. 13, the display 76 is equipped with LEDs that are capable of lighting in the region of a respective portion. The notifier 760 provides notification by causing lighting of the LEDs of items that are presently pertinent, among items that are whether a power consumption reduction has been requested, whether a power consumption reduction is in progress, whether a power consumption reduction amount has reached a limit, and whether power consumption reduction has priority over user operations.

Specifically, upon the request acquirer 710 acquiring the power consumption reduction request, the notifier 760 causes lighting of the LED indicating “power reduction request”. Then in the case in which the power consumption is reduced by the power controller 750, the notifier 760 causes lighting of the LED indicating “power reduction in progress”. Further, in the case in which the power consumption is reduced by the power controller 750, as illustrated in FIG. 14, the notifier 760 displays on the display 76 a notification image indicating that presently a response to a power consumption reduction request is in progress. In this manner, the notifier 760 provides notification of reduction of the power consumption of the power consumer 700. Thus the user can easily understand that power consumption is reduced.

Further, in the case in which the power consumption reduction amount is reaching the limit thereof, the notifier 760 causes lighting of the LED indicating “power reduction limit”, and in the case in which the power consumption reduction amount is not reaching the limit thereof, the notifier 760 causes lighting of the LED indicating “power reduction capacity”. Thus the notifier 760 provides notification of whether the reduction amount of the power consumption reaching the limit. The phrase “reduction amount of the power consumption reaching the limit” means that the power consumption reduction amount reaches an upper limit power of the reduction request determined by the control range adjusted by the control range adjuster 740. In the example illustrated in FIG. 14, the upper limit power of the reduction request is 150 W, versus the reduction request power of 100 W. Thus the limit of the power consumption reduction amount is not reached, and capacity arises for power reduction. In this case, as illustrated in FIG. 13, the notifier 760 does not cause lighting of the LED indicating “power reduction limit” and causes lighting of the LED indicating “power reduction capacity”.

Further, in the case in which the reduction of the power consumption by the power consumer 700 is given priority over a user operation of the electrical apparatus 7, the notifier 760 causes lighting of the LED indicating “power reduction priority”. Thus the notifier 760 provides notification of whether the power consumption reduction amount is given priority over the user operation. In the case in which the power consumption reduction is given priority over the user operation, upon reception of an operation of the electrical apparatus 7 from the user via the operation receiver 770, if the operation causes an increase in the power consumption, the power controller 750 does not allow running of the power consumer 700 in accordance with the received operation. Conversely, in the case in which the user operation is given priority over the power consumption reduction, upon reception of an operation of the electrical apparatus 7 from the user via the operation receiver 770, even if the operation causes an increase in the power consumption, the power controller 750 causes running of the power consumer 700 in accordance with the received operation. Whether the power reduction of the electrical apparatus 7 is given priority or the user operation is given priority can be set by the user via the operation receiver 770, or can be set by the controller 71 in accordance with a prerecorded schedule.

Further, the notifier 760 provides, via the notification image illustrated in FIG. 14, notification of the operating state of the electrical apparatus 7 after the reduction of the power consumption by the power controller 750. The expression “operating state of the electrical apparatus 7 after the reduction of the power consumption” means the operation mode, power consumption, or the like of the electrical apparatus 7 after the reduction of the power consumption. Specifically, as illustrated in FIG. 14, the notifier 760 provides notification that the (present) operation after the reduction of the power consumption is cooling, and that the power consumption is lowered (setting temperature of cooling is raised) relative to the power consumption prior to the reduction (prior to suppression). Further, the notifier 760 provides notification that the present power consumption is 200 W. Due to notification in this manner, the user can easily understand the reason for a change of the operating state, and the present operating state, of the electrical apparatus 7.

Further, among the items that are whether the power consumption reduction amount has reached the limit, whether the power consumption reduction has priority over user operations, and the operating state of the electrical apparatus 7 after reduction of the power consumption, the notifier 760 is not limited to notification of all items, and notification may be provided for at least one of these items. Further, the notifier 760, rather than displaying the notification image using the user interface 73, can display the notification image in the aforementioned manner on the display of the operation terminal 3 by communication with the operation terminal 3 via the communicator 74. Further, the notifier 760 can output a notification such that described above by sound output rather than the display. In this manner, the notifier 760 is achieved by the controller 71 in cooperation with the display 76, the communicator 74, and the like.

The operation receiver 770 receives from the user an operation of the electrical apparatus 7. The user can input the operation of the electrical apparatus 7 via the inputter 77 of the user interface 73 or the operation terminal 3. The operation receiver 770 receives the operation inputted by the user in this manner. For example, upon the operation receiver 770 receiving an operation that starts the heating operation of the electrical apparatus 7a that is the air conditioner, the power controller 750 controls the power consumer 700 to start the heating operation. The same is true for other operation modes and other types of the electrical apparatus 7. The operation receiver 770 is achieved by the controller 71 in cooperation with the display 76, the communicator 74, and the like.

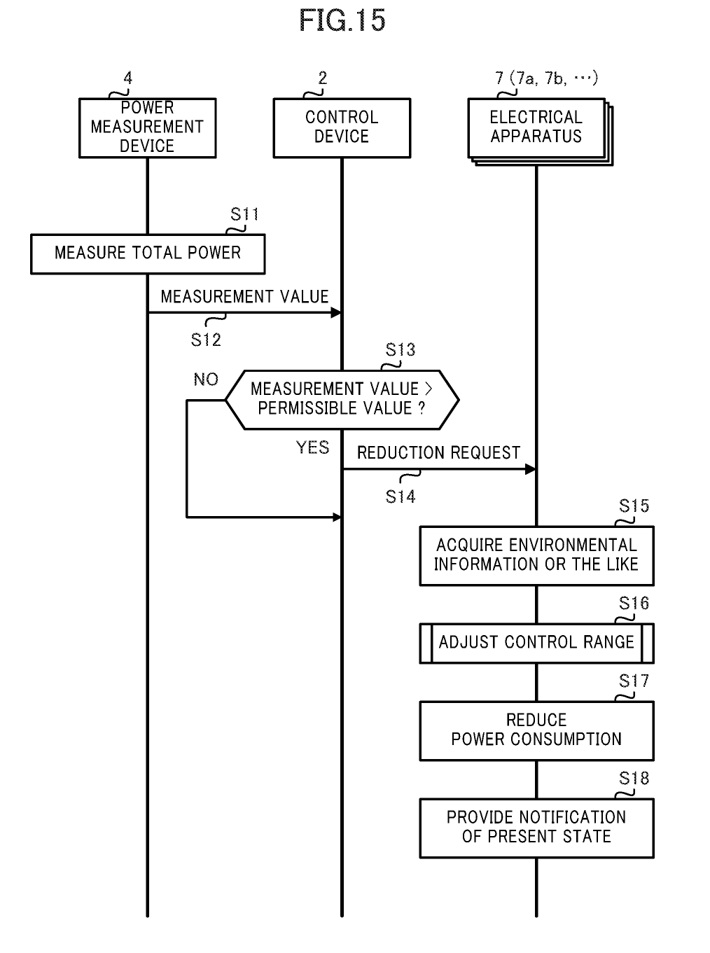

The processing executed by the power consumption reduction system 1 in the aforementioned manner is described with reference to FIGS. 15, 16, and 17.

FIG. 15 illustrates processing executed by the power measurement device 4, the control device 2, and the electrical apparatus 7 of the power consumption reduction system 1.

The power measurement device 4 measures total power supplied to the home H from the commercial power system 8 (step S11). Such “total power” corresponds to the power P1 sold from the commercial power system 8 to the home H.

Upon measurement of the total power, the power measurement device 4 transmits the obtained measurement value of the total power to the control device 2 via the network installed in the home H (step S12). The power measurement device 4 repeatedly measures the total power in this manner and performs the processing of transmission to the control device 2 in a predetermined cycle, or every time the power measurement device 4 receives the request from the control device 2.

Upon the power measurement device 4 transmitting the measurement value of the total power in step S12, the controller 21 of the control device 2 acquires the transmitted measurement value. At this time, the controller 21 functions as the measurement value acquirer 210.

Upon acquiring the measurement value, the controller 21 determines whether the acquired measurement value is larger than a predetermined permissible value (step S13). Specifically, the controller 21 compares the measurement value, acquired from the power measurement device 4, of the total power with the predetermined permissible value as an upper limit value of electrical energy permitted to be consumed in the home H, and the controller 21 determines whether the measurement value is greater than or equal to the permissible value. The controller 21 in step S13 functions as the determiner 220.

In the case in which the measurement value is greater than the permissible value (YES in step S13), the controller 21 transmits the reduction request for power consumed by the electrical apparatus 7 via the wireless network installed in the home H to each of the electrical apparatuses 7a, 7b, and the like in the home H (step S14). The controller 21 in step S14 functions as the request transmitter 230.

In contrast, in the case in which the measurement value is less than or equal to the permissible value (NO in step S13), the controller 21, without transmitting to any of the electrical apparatuses 7 the reduction request for power consumed by the electrical apparatus 7 in the home H, waits until the measurement value of the total power is next acquired from the power measurement device 4. Every time the control device 2 acquires the measurement value of the power P1 from the power measurement device 4, the control device executes transmission processing of the reduction request in this manner.

Upon the control device 2 transmitting the reduction requests in step S14, the controller 71 of the respective electrical apparatus 7a, 7b, and the like acquires the transmitted reduction request. At this time, the controller 71 functions as the request acquirer 710.

Upon acquiring the reduction request, the controller 71 executes power consumption reduction processing. In the state in which the electrical apparatus 7 is running, that is, the state in which power is being consumed by the electrical apparatus 7, the power consumption range processing starts upon acquisition of the reduction request from the control device 2.

Upon the start of the power consumption reduction processing, the controller 71 acquires at least one of the environmental information, the apparatus information, or the time information (step S15). Specifically, the controller 71 acquires at least one of: the environmental information such as the temperature, humidity, illuminance, sound volume, the presence of persons, or the presence of pets; the apparatus information such as the remaining hot water amount or charge amount; or the time information such as the time or season. The controller 71 in step S15 functions as the information acquirer 730.

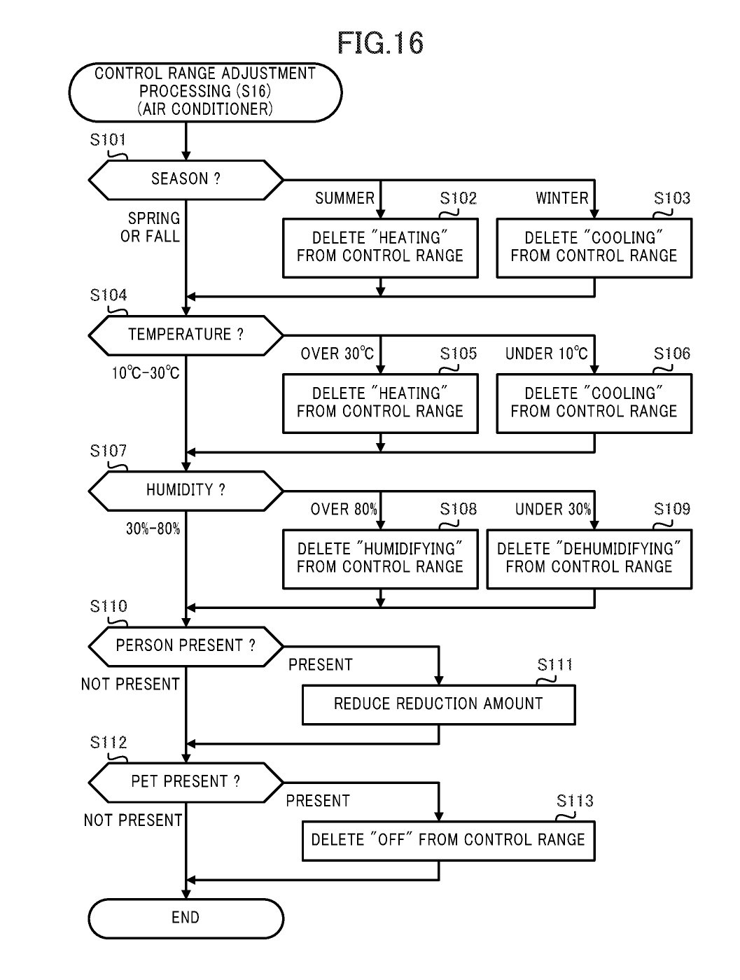

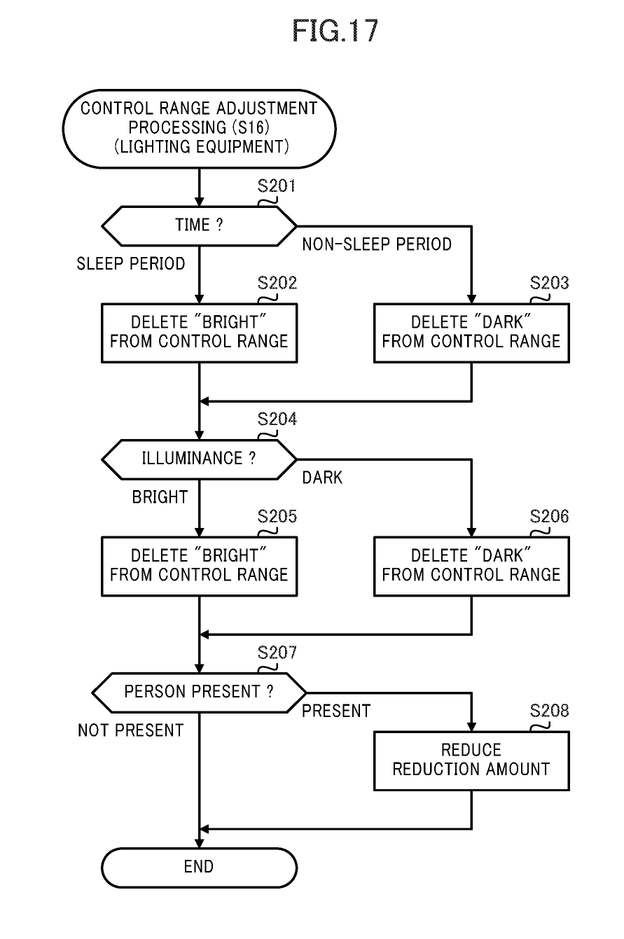

Upon acquiring the environmental information or the like, the controller 71 adjusts the control range of the power consumption (step S16). The controller 71 in step S16 executes processing that differs in accordance with the type of the electrical apparatus 7. For example, the electrical apparatus 7a that is the air conditioner executes the control range adjustment processing illustrated in FIG. 16. In contrast, the electrical apparatus 7b that is the lighting equipment executes the control range adjustment processing illustrated in FIG. 17. The controller 71 in step S16 functions as the control range adjuster 740.

The control range adjustment processing executed by the electrical apparatus 7a that is the air conditioner is described with reference to FIG. 16. Upon the start of the control range adjustment processing, the controller 71 firstly determines the present season (step S101). Specifically, the controller 71 refers to the time information acquired in step S15, and determines the season to which the present date-time belongs.

In the case in which the present season is summer (“summer” in step S101), the controller 71 deletes from the control range the range of power consumed during the heating operation (step S102). In contrast, in the case in which the present season is winter (“winter” in step S101), the controller 71 deletes from the control range the range of power consumed during the cooling operation (step S103). In the case in which the present season is the spring or fall (“spring” or “fall” in step S101), the controller 71 does not change the control range.

Secondly, the controller 71 determines the ambient temperature (step S104). Specifically, the controller 71 refers to the environmental information acquired in step S15, and then determines: whether the present indoor or outdoor temperature exceeds the first reference temperature (assumed to be 30° C. here as an example), and whether the present indoor or outdoor temperature is less than the second reference temperature (assumed to be 10° C. here as an example).

In the case in which the ambient temperature exceeds 30° C. (“above 30° C.” in step S104), the controller 71 deletes from the control range the range of power consumed during the heating operation (step S105). In contrast, in the case in which the ambient temperature is less than 10° C. (“below 10° C.” in step S104), the controller 71 deletes from the control range the range of power consumed during the cooling operation (step S106). In the case in which the ambient temperature is greater than or equal to 10° C. and is less than or equal to 30° C. (10° C. to 30° C.″ in step S104), the controller 71 does not change the control range.

Thirdly, the controller 71 determines the ambient humidity (step S107). Specifically, the controller 71 refers to the environmental information acquired in step S15, and determines: whether the present indoor or outdoor humidity exceeds the first reference humidity (assumed to be 80% here as an example), and whether the present indoor or outdoor humidity is less than the second reference humidity (assumed to be 30% here as an example).

In the case in which the ambient humidity exceeds 80% (“above 80%” in step S107), the controller 71 deletes from the control range the range of power consumed during the dehumidifying operation (step S108). In contrast, in the case in which the ambient humidity is less than 30% (“below 30%” in step S107), the controller 71 deletes from the control range the range of power consumed during the dehumidifying operation (step S109). In the case in which the ambient humidity is greater than or equal to 30% and is less than or equal to 80% (“30% to 80%” in step S107), the controller 71 does not change the control range.

Fourthly, the controller 71 determines whether persons are present (step S110). Specifically, the controller 71 determines whether a person is present within the room in which the electrical apparatus 7a is installed, on the basis of sensor information of an infrared sensor included in the environmental information acquired in step S15.

In the case in which a person is present in the room (“present” in step S110), the controller 71 decreases the reduction amount of the power consumption (step S111). Specifically, the controller 71, by multiplying a coefficient less than one times the reduction amount of the power consumption determined in accordance with the reduction request acquired by the request acquirer 710, makes the reduction amount smaller than the amount in accordance with the reduction request. In contrast, in the case in which a person is not present in the room (“absent” in step S110), the controller 71 does not change the reduction amount.

Fifthly, the controller 71 determines whether a pet is present (step S112). Specifically, the controller 71 determines whether a pet is present within the room in which the electrical apparatus 7a is installed, on the basis of sensor information of the infrared sensor included in the environmental information acquired in step S15.

In the case in which a pet is present in the room (“present” in step S112), so that the air conditioner does not stop operation, the controller 71 deletes from the control range the range of power consumed when the air conditioner is OFF (step S113). In contrast, when a pet is not present in the room (“absent” in step S112), the controller 71 does not change the control range. The control range adjustment processing of FIG. 16 is completed in the above manner.

The control range adjustment processing executed by the electrical apparatus 7b that is the lighting equipment is described next with reference to FIG. 17. Upon starting of the control range adjustment processing, firstly the controller 71 determines the present time (step S201). Specifically, the controller 71 refers to the time information acquired in step S15 and determines whether the present time is included in the predetermined sleep period.

In the case in which the present time is included in the sleep period (“sleep period” in step S201), the controller 71 deletes from the control range the range of power consumed when illuminance is high (bright) (step S202). The controller 71 lowers the upper limit of the control range by such processing. In contrast, in the case in which the present time is not included in the sleep period (“non-sleep period” in step S201), the controller 71 deletes from the control range the range of power consumed when illuminance is low (dark) (step S203). The controller 71 raises the lower limit of the control range by such processing.

Secondly, the controller 71 determines the ambient illuminance (step S204). Specifically, the controller 71 refers to the environmental information acquired in step S15, and determines whether the ambient illuminance minus the illuminance due to the electrical apparatus 7b itself is larger than the reference illuminance.

In the case in which the ambient illuminance is greater than the reference illuminance (“bright” in step S204), the controller 71 deletes from the control range the range of power consumed when the illuminance is high (bright) (step S205). The controller 71 in this manner lowers the upper limit of the control range. In contrast, in the case in which the ambient illuminance is less than the reference illuminance (“dark” in step S204), the controller 71 deletes from the control range the range of power consumed when the illuminance is low (dark) (step S206). The controller 71 in this manner raises the lower limit of the control range.

Thirdly, the controller 71 determines the presence of persons (step S207). Specifically, the controller 71, on the basis of the sensor information of the infrared sensor included in the environmental information acquired in step S15, determines whether a person is present in the room in which the electrical apparatus 7b is installed.

In the case in which a person is present in the room (“present” in step S207), the controller 71 decreases the reduction amount of the power consumption (step S208). Specifically, by multiplying a coefficient smaller than one times the reduction amount of the power consumption determined in accordance with the reduction request acquired by the request acquirer 710, the controller 71 makes the reduction amount smaller than the amount in accordance with the reduction request. In contrast, in the case in which the person is not present in the room (“absent” in step S207), the controller 71 does not change the reduction amount. The control range adjustment processing of FIG. 17 is completed in the above manner.

FIG. 15 is further described. Upon adjustment of the control range of the power consumption, the controller 71 reduces the power consumption of the power consumer 700 (step S17). Specifically, the controller 71 reduces the power consumed by the power consumer 700 to be within the control range adjusted by the control range adjuster 740. For example, the controller 71 of the air conditioner reduces the power consumption by lessening the capacity of cooling, heating, dehumidifying, humidifying, or air circulating. Further, the controller 71 of the lighting equipment reduces the power consumption by reducing the illuminance. The controller 71 in step S17 functions as the power controller 750.

Upon reducing the power consumption to the power within the control range, the controller 71 sends, to the user, notification of the present state of the electrical apparatus 7 (step S18). Specifically, the controller 71, by displaying on the user interface 73 or the operation terminal 3 the notification image illustrated in FIG. 11 or 12, provides notification of the control range adjusted in step S16. Further, the controller 71, by displaying on the user interface 73 or the operation terminal 3 the notification image illustrated in FIG. 13 or 14, provides notification of the control content of step S17. The controller 71 in step S18 functions as the notifier 760.

Every time the reduction request is acquired from the control device 2, each of the electrical apparatuses 7a, 7b, and the like executes the power consumption reduction processing in this manner. The processing of the power consumption reduction system 1 of FIG. 15 is completed in the above manner.

According to the power consumption reduction system 1 of Embodiment 1 in the above-described manner, in the case in which the power P1 supplied to the home H from the commercial power system 8 is larger than the permissible value, the control device 2 transmits the power consumption reduction request to each of the electrical apparatuses 7a, 7b, and the like in the home H. Then in the case in which the reduction request is acquired from the control device 2, each of the electrical apparatuses 7a, 7b, and the like controls the power consumer 700 to reduce the power consumed by the power consumer 700 on the basis of at least one of the environmental information relating to the ambient environment of the local apparatus, the apparatus information relating to the local apparatus, or the time information.

Reduction in the convenience and comfort of the user can be suppressed by determining the reduction amount of the power consumption on the basis of the environmental information or the like, without reducing the power consumption per the request as is. Further, the user is not required to control the electrical apparatus 7, and thus power consumption can be reduced without user effort.

Further, for each of the electrical apparatuses 7a, 7b, and the like, the control range of the power consumption is adjusted on the basis of at least one of the environmental information, the apparatus information, or the time information, and the power consumption is reduced to the power within the control range adjusted by the control range adjuster 740. By adjustment of the control range of the power consumption on the basis of the environmental information or the like, unnecessary consumption of power can be suppressed, while suppressing lessening of convenience and comfort of the user. Further, by limiting the control range of the power consumption, suppression of control unintended by the user is possible, and the user can easily control the electrical apparatus 7 in a suitable manner.

This type of power consumption reduction system 1 is particularly effective in the case of a limitation of the power capable of consumption by the overall home H, for example, such as when a demand response is issued, or when control of power consumption is desired from the standpoints of economics or the environment.

### Embodiment 2

Embodiment 2 of the present disclosure is described next.

In Embodiment 1, upon the request acquirer 710 acquiring the reduction request, the power controller 750 controls the power consumer 700 on the basis of at least one of the environmental information, the apparatus information, or the time information, and the power consumed by the power consumer 700 is reduced. However, in the case in which the reduction of the power consumption of the electrical apparatus 7 becomes unnecessary thereafter, the electrical apparatus 7 is not guaranteed to be able to acquire from the control device 2 a command indicating that the reduction range is unnecessary. Even assuming that the command indicating that the reduction is unnecessary is transmitted by the control device 2, such transmission sometimes fails.

In order to solve this difficulty, in Embodiment 2, in the case in which request acquirer 710 has not acquired a new request to reduce the power consumed by the power consumer 700 prior to elapsing of a determined period after the acquisition of the reduction request, the power controller 750 causes the power consumed by the power consumer 700 to increase to the pre-reduction power.

The term “pre-reduction power” refers to the power consumption of the power consumer 700 prior to the reduction in accordance with the reduction request from the control device 2. For example, after the power controller 750, in accordance with a first request from the control device 2, reduces to a second power from a first power the power consumed by the power consumer 700, then in the case in which a second request that is the next reduction request is not acquired by the request acquirer 710 before the elapse of the determined period, the power controller 750 controls the power consumer 700 so as to cause the power consumed by the power consumer 700 to increase from the second power to the first power. Thus the power controller 750 returns the state of the electrical apparatus 7 to the original state prior to the power reduction.

At this time, the power controller 750 may cause the power consumed by the power consumer 700 to increase quickly or gradually to the pre-reduction power. In this manner, in the case in which there is no reduction request in the predetermined period, such operation enables minimization of the period of the reduction of the power consumption until the electrical apparatus 7 returns to the state prior to the reduction. Thus the convenience and comfort of the user can be increased.

### Embodiment 3

Embodiment 3 of the present disclosure is described next.

In Embodiment 1, upon the request acquirer 710 acquiring the reduction request, the power controller 750 controls the power consumer 700 on the basis of at least one of the environmental information, the apparatus information, or the time information, and the power consumed by the power consumer 700 is reduced. In contrast, in Embodiment 3, upon the request acquirer 710 acquiring the reduction request, the power controller 750 controls the power consumer 700 on the basis of the content of the operation received by the operation receiver 770 and at least one of the environmental information, the apparatus information, or the time information, and reduces the power consumed by the power consumer 700.

Specifically, upon the request acquirer 710 acquiring the reduction request, the control range adjuster 740 adjusts the control range of power consumed by the power consumer 700 on the basis of the content of the operation received by the operation receiver 770 and at least one of the environmental information, the apparatus information, or the time information. For example, upon the operation receiver 770 receiving an operation to raise the setting temperature of cooling for the electrical apparatus 7a that is the air conditioner, the user is determined to be a person who feels the cold easily and does not require strong cooling. Thus the control range adjuster 740 lowers the upper limit of the control range. Conversely, upon the operation receiver 770 receiving an operation to lower the setting temperature of cooling, the control range adjuster 740 raises the upper limit of the control range. In the case of heating, upon the operation receiver 770 receiving an operation to raise the setting temperature, the control range adjuster 740 raises the upper limit of the control range, and upon the operation receiver 770 receiving an operation to lower the setting temperature, the control range adjuster 740 lowers the upper limit of the control range. Further, upon the operation receiver 770 receiving an operation to raise the illuminance for the electrical apparatus 7b that is the lighting equipment, the user is determined to be a person who likes brightness, and the upper limit of the control range is raised. Conversely, upon the operation receiver 770 receiving an operation to lower the illuminance, the user is determined to be a person who likes darkness, and the upper limit of the control range is lowered.

The power controller 750 reduces the power consumption to a power within the control range adjusted in accordance with user preference in this manner. The other structure of the power consumption reduction system 1 is similar to the structure described for Embodiment 1. Becoming aware of user preferences is initially difficult. However, by the determination of user preferences on the basis of the content of operations during running of the electrical apparatus 7 in this manner, the control range can be more suitably adjusted in accordance with the individual user.

### Modified Examples

Although embodiments of the present disclosure are described above, modifications and applications based on various aspects are possible in implementing the present disclosure.

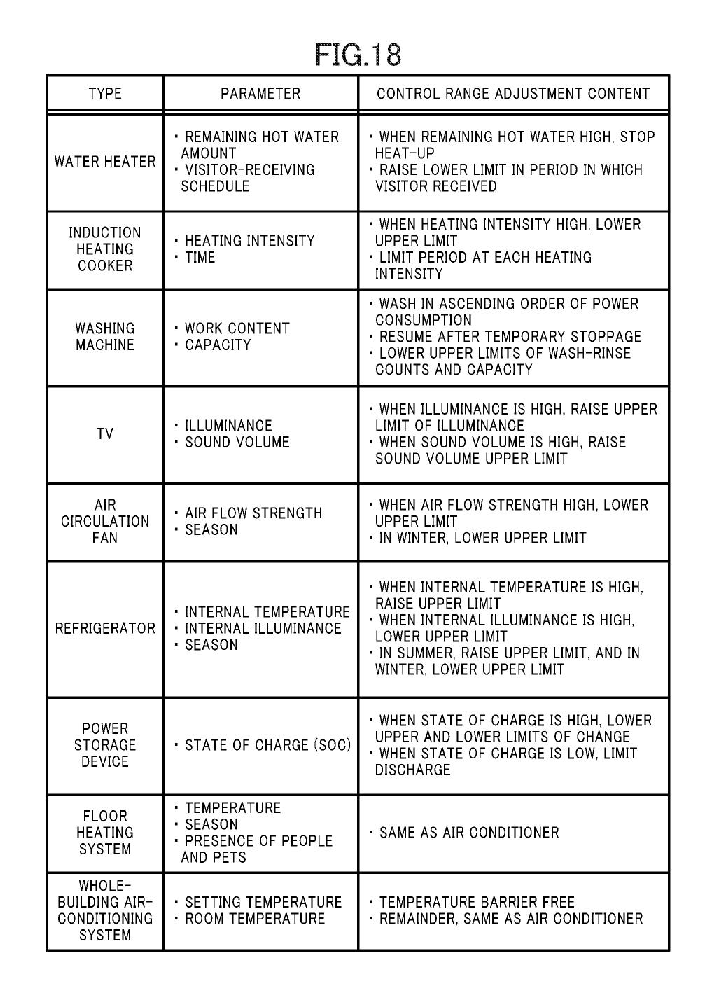

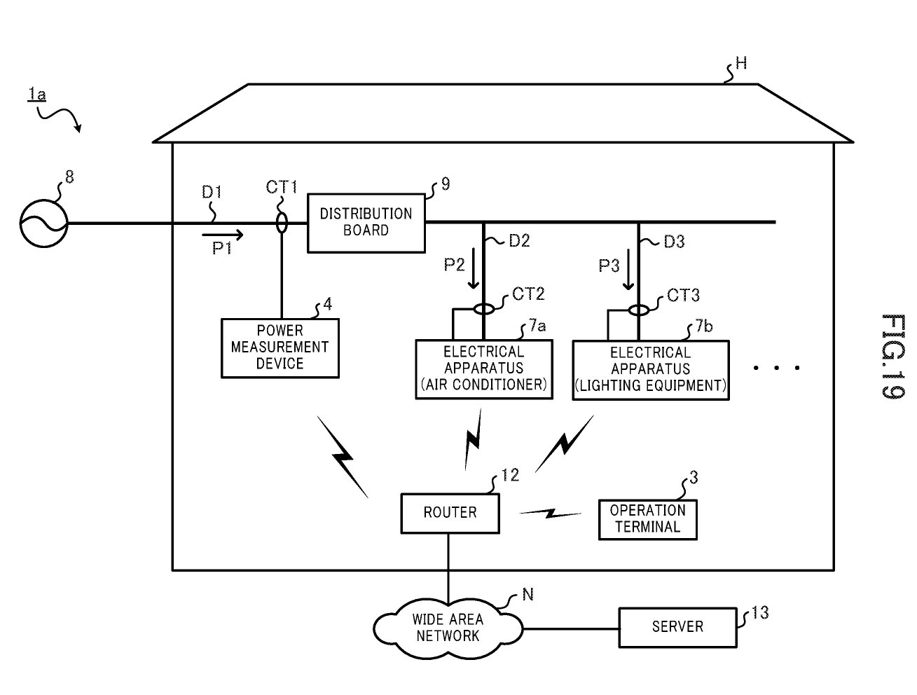

For example, in the aforementioned embodiments, examples are cited and described in which the electrical apparatus 7 is the air conditioner and the lighting equipment. However, the electrical apparatus 7 in the present disclosure may be another type of apparatus. FIG. 18 lists a summary of adjustment examples of the control range of various types of electrical apparatuses 7. Some of these apparatus types are described below.

In the case in which the electrical apparatus 7 is a water heater, the information acquirer 730, as the parameters for adjustment of the control range, acquires the remaining hot water amount within the water heater that is the apparatus information, and acquires a visitor-receiving schedule that is the time information. Upon the request acquirer 710 acquiring the reduction request while the water heater is heating water, the power controller 750, does not stop the heating of water if the remaining hot water amount within the water heater is less than a reference amount, and stops the heating up of water if the remaining hot water amount is greater than the reference amount. That is to say, heating water is given priority when the remaining hot water amount is small, and stopping of water heating and reduction of power is given priority when the remaining hot water amount is large. Further, the power controller 750 may restart heating when a determined period is passed after the stoppage of water heating. Also, the control range adjuster 740 raises the lower limit of the control range in the case in which the visitor-receiving schedule is referred to and the present time is determined to correspond to a time when a visitor is received. Heating of water is thus given priority. Further, a period in which hot water is used other than the period when a visitor is received may be forecast.

In the case in which the electrical apparatus 7 is an induction heating cooker, the information acquirer 730 acquires, as a parameter for adjustment of the control range, heating intensity of the induction heating cooker that is apparatus information. The control range adjuster 740, lowers the upper limit of the control range in the case in which the heating intensity of the induction heating cooker during the heating operation is higher than the reference value, in comparison to the case in which the heating intensity is lower than a reference value. By lowering the upper limit of the control range, in the case in which the acquirer 710 acquires the reduction request, the power controller 750 heats over a long period at low heating intensity. Thus the power consumption of the induction heating cooker is reduced. Further, such limitation of the heating intensity can be forcibly deleted by user operation.

In the case in which the electrical apparatus 7 is a power storage device, the charging power corresponds to the power consumption of the electrical apparatus 7. The “power storage device” is a device such as a power conditioning system (PCS) for an electric vehicle (EV), or a stationary-type storage battery. In this case, the information acquirer 730 acquires, as the parameter for adjustment of the control range, a state of charge (SOC) that is the apparatus information. In the case in which the present state of charge is higher than a reference value, the control range adjuster 740 lowers an upper limit and a lower limit of the control range of the charging power in comparison to the case in which the present state of charge is lower than the reference value. Due to lowered likelihood of charging of the EV-PCS or the power storage device when the state of charge is high, such operation causes a reduction of the power consumption. In contrast, when the present state of charge is lower than the reference value, the control range adjuster 740 limits discharge in order to suppress lowering of the state of charge.

In the case in which the electrical apparatus 7 is a floor heating system, the information acquirer 730, as parameters for adjustment of the control range, acquires the ambient temperature that is the environmental information, the presence of persons, the presence of pets, and the season that is the time information. The adjustment content of the control range is similar to the adjustment content in the case in which the electrical apparatus 7 is the air conditioner.

In the case in which the electrical apparatus 7 is a whole-building air-conditioning system, the information acquirer 730, as the parameters for adjustment of the control range, acquires the setting temperatures and the room temperatures, that are the environmental information, of each of the rooms. The control range adjuster 740 adjusts the control range of each room such that differences in room temperatures of adjacent rooms are smaller than a prescribed value. For example, in the case in which the temperature of the first room is lower, by at least a prescribed value, than the temperature of a second room adjacent to the first room, the upper limit of the setting temperature of the first room is raised above the upper limit of the setting temperature of the second room. Such operation prevents adverse health effects due to large inter-room temperature differences.

Further, in the aforementioned modified examples, the power consumption reduction request transmitted from the control device 2 indicates a reduction command amount for the overall home H or apparatus-by-apparatus. However, the reduction request may indicate just that the power consumption is to be reduced at each of the electrical apparatuses 7a, 7b, and the like, without indicating the reduction command amounts. In this case, upon acquisition of the reduction request, each of the electrical apparatuses 7a, 7b, and the like determines the reduction amount in accordance with a separate reference for each of the apparatuses.

Further, in the case in which a sequence of reduction range requests is acquired by the request acquirer 710 in a short period for each of the electrical apparatuses 7a, 7b, and the like, the power controller 750 does not comply with all of the reduction requests. Specifically, after the request acquirer 710 receives a first request, then upon the acquiring of a further second request prior to elapsing of a predetermined threshold period, the power controller 750 reduces the power consumption in accordance with just the later-received second request. Alternatively, the power controller 750 may determine the reduction amount to be an average value of the reduction command amount of the first request and the reduction command amount of the second request. Processing is similar when the reduction range request is transmitted from multiple devices rather than transmitted from a single control device 2. Thus even when a sequence of transmissions of the reduction request occurs in a short period, excessive reduction of the power consumption is suppressed.

Further, for each of the electrical apparatuses 7a, 7b, and the like, the controller 750 may gradually reduce the power when reducing the power consumed by the power consumer 700. Specifically, upon the request acquirer 710 acquiring the reduction request, the power controller 750 step-wise reduces the power consumed by the power consumer 700 in predetermined amounts of power each time a predetermined period elapses, until the power consumed by the power consumer 700 is reduced to a target reduction amount. By reduction of the power amount in this manner over a period, rapid change in the state of the electrical apparatus 7 can be prevented. Thus decline in user comfort can be suppressed.

In the aforementioned embodiments, the electrical apparatus 7 acquires the reduction request from the control device 2, and then adjusts the power consumed at the power consumer 700. However, the aforementioned embodiments may use a communication adapter externally attached to the electrical apparatus 7 and electrically connected to the electrical apparatus 7, the communication adaptor having the functions of the request acquirer 710, the measurement value acquirer 720, the information acquirer 730, the control range adjuster 740, the power controller 750, the notifier 760, the present power consumption storage 780, and the power consumption distribution storage 790 that are included in the electrical apparatus 7.

In the case in which the communication adapter is equipped with the functions provided to the electrical apparatus 7 in the aforementioned embodiments, the request acquirer 710 acquires the request for reducing the power consumed by the power consumer 700 of the electrical apparatus 7 to which the communication adapter is connected. This request is transmitted from the control device 2 when the measurement value of the power P1 supplied to the home H from the commercial power system 8 is greater than or equal to the permissible value. The measurement value acquirer 720 acquires the measurement value of the power consumed by the electrical apparatus 7. The present power consumption storage 780 stores as the present power consumption of the electrical apparatus 7 the measurement value of power acquired by the measurement value acquirer 720. The power consumption distribution storage 790 stores the power consumption distribution of the electrical apparatuses 7 capable of connection to this communication adapter. The information acquirer 730 acquires at least one of the environmental information relating to the ambient environment of the electrical apparatus 7 to which this communication adapter is connected, the apparatus information relating to the electrical apparatus 7, or the time information. The control range adjuster 740 adjusts the control range of the power consumed by the power consumer 700 on the basis of at least one of the environmental information, the apparatus information, or the time information acquired by the information acquirer 730. Upon the request acquirer 710 acquiring the reduction request from the control device 2, the power controller 750 controls the power consumer 700 on the bases of at least one of the environmental information, the apparatus information, or the time information acquired by the information acquirer 730, and reduces the power consumed by the power consumer 700. The notifier 760, via the user interface 73 or the operation terminal 3, provides notification of the control range adjusted by the control range adjuster 740, and the control content of the power controller 750.

The communication adapter is equipped with components (none illustrated) such as a CPU, ROM, RAM, communication interface, and read-writeable non-volatile semiconductor memory. The functions of each of the aforementioned components are achieved by the CPU executing programs stored in the ROM. Due to equipping of the communication adapter with such functions, the aforementioned power consumption reduction processing can be executed even by a general-purpose electrical apparatus 7.

Further, in the aforementioned embodiments, cases are described in which the control device 2 is arranged in the home H. However, in the present disclosure, a device having functions equivalent to the control device 2 may be arranged outside the home H. FIG. 19 illustrates an example of a power consumption reduction system 1a in this case. In the power consumption reduction system 1a illustrated in FIG. 19, rather than the control device 2, a router 12 is arranged in the home H. The router 12 is a device capable of communication with a server 13 via a wide area network N, and for example, is a broadband router. The server 13 is a server that supplies resources that occur in cloud computing. The wide area network N, for example, is a wide area network (WAN) such as the Internet. In this case, the router 12 and the server 13 cooperatively perform the role of the control device 2.

Further, in the aforementioned embodiments, the home H is described as an example of the power consumption site. However, the power consumption site is not limited to a general residence such as the home H, and as long as the power consumption site is an area in which electrical apparatuses 7 are arranged that consume power received by the supply of power from the commercial power system 8, the power consumption site may be collective housing, a facility, a building, a factory, or the like.

In the aforementioned embodiments, the operation terminal 3 is equipped with the display and the inputter, and the control device 2 acquires the inputted information inputted at the operation terminal 3 via the terminal communicator 24. However, in the present disclosure, the control device 2 may be equipped with the display and the inputter. That is to say, the control device 2 itself may be provided with the functions of the operation terminal 3.

In the control device 2 of the controller 21 of the aforementioned embodiments, each of the functions of the measurement value acquirer 210, the determiner 220, and the request transmitter 230 are performed by the CPU executing programs stored in the ROM or the storage 22. Further, in the controller 71 of the electrical apparatus 7, each of the functions of the request acquirer 710, the measurement value acquirer 720, the information acquirer 730, the control range adjuster 740, the power controller 750, and the notifier 760 are performed by the CPU executing programs stored in the ROM and the storage 72. However, in the present disclosure, the controllers 21 and 71 may be dedicated hardware. The term “dedicated hardware” means, for example, a single circuit, a composite circuit, a programmed processor, an application specific integrated circuit (ASIC), a field-programmable gate array (FPGA), or a combination of such hardware. When the controller 21 or 71 is dedicated hardware, the functions of the components may be achieved by separate hardware units, of the functions of the components may be achieved by a single hardware unit.

Further, among the functions of the components, a portion of the functions may be achieved by hardware, and the other portion may be achieved by software or firmware. In this manner, the controllers 21 and 71 can achieve the aforementioned functions by hardware, software, firmware, or a combination of such.

By application of an operating program specifying the operations of the control device 2, the electrical apparatus 7, and the communication adapter in accordance with the present disclosure to a computer such as an existing personal computer, an information terminal, or the like, the computer can be made to function as each of the control device 2, the electrical apparatus 7, and the communication adapter according to the present disclosure.

Further, any method may be used for distribution of such a program, and for example, the program may be stored in a computer-readable recording medium such as a compact disc read-only memory (CD-ROM), a digital versatile disc (DVD), a magneto-optical (MO) disc, a memory card, or the like and distributed, and the program may be distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be used with advantage for a system for management of power and the like.

1. An electrical apparatus comprising:
a power consumer configured to consume power;
a request acquirer configured to acquire a request for reducing the power consumed by the power consumer; and
a power controller configured to control, upon acquisition of the request by the request acquirer, the power consumer based on at least one of environmental information regarding an ambient environment of the electrical apparatus, apparatus information regarding the electrical apparatus, or time information, to reduce the power.

2. The electrical apparatus according to claim 1, further comprising:
a control range adjuster configured to adjust a control range of the power consumed by the power consumer based on at least one of the environmental information, the apparatus information, or the time information, wherein
upon acquisition of the request by the request acquirer, the power controller reduces the power consumed by the power consumer to be within the control range adjusted by the control range adjuster.

3. The electrical apparatus according to claim 2, wherein
when power that is obtained by reducing the power consumed by the power consumer by an amount of power determined in accordance with the request is in the control range, the power controller reduces the power consumed by the power consumer by the determined amount of power, and
when the power that is obtained by reducing the power consumed by the power consumer by the amount of power determined in accordance with the request is not in the control range, the power controller reduces the power consumed by the power consumer to be within the control range.

4. The electrical apparatus according to claim 2, wherein
the electrical apparatus is an air conditioner or a floor heating system,
when a present season is summer or when an ambient temperature of the electrical apparatus is higher than a first reference temperature, the control range adjuster does not include in the control range the power consumed by the power consumer during a heating operation, and
when the present season is winter or when the ambient temperature of the electrical apparatus is lower than a second reference temperature, the control range adjuster does not include in the control range the power consumed by the power consumer during a cooling operation.

5. The electrical apparatus according to claim 2, wherein
the electrical apparatus is an air conditioner,
when an ambient humidity of the electrical apparatus is higher than a first reference humidity, the control range adjuster does not include in the control range the power consumed by the power consumer during a humidifying operation, and
when the ambient humidity of the electrical apparatus is lower than a second reference humidity, the control range adjuster does not include in the control range the power consumed by the power consumer during a dehumidifying operation.

6. The electrical apparatus according to claim 2, wherein
the electrical apparatus is lighting equipment, and
when a present time is included in a predetermined sleep period or when an ambient illuminance of the electrical apparatus is larger than a reference illuminance, the control range adjuster lowers an upper limit of the control range below an upper limit of the control range used when the present time is not included in the sleep period or when the ambient illuminance of the electrical apparatus is less than the reference illuminance.

7. The electrical apparatus according to claim 4, wherein
when a person is not present within a room in which the electrical apparatus is disposed, the power controller reduces the power consumed by the power consumer greater than when the person is present within the room.

8. The electrical apparatus according to claim 2, wherein
the electrical apparatus is an induction heating cooker, and
when a heating intensity of the induction heating cooker is greater than a reference value, the control range adjuster lowers an upper limit of the control range in comparison to when the heating intensity is smaller than the reference value.

9. The electrical apparatus according to claim 1, wherein
the electrical apparatus is a water heater, and
upon acquisition of the request by the request acquirer during heating of water by the water heater, the power controller (i) does not stop the heating of water when a remaining hot water amount in the water heater is less than a reference value, and (ii) stops the heating of water when the remaining hot water amount in the water heater is greater than the reference value.

10. The electrical apparatus according to claim 1, wherein
when the request acquirer does not acquire a new request to reduce the power consumed by the power consumer prior to elapsing of a determined period after acquisition of the request by the request acquirer, the power controller causes the power consumed by the power consumer to increase to a pre-reduction power.

11. The electrical apparatus according to claim 1, further comprising:
an operation receiver configured to receive an operation of the electrical apparatus from a user, wherein
upon acquisition of the request by the request acquirer, the power controller reduces the power consumed by the power consumer based on (i) at least one of the environmental information, the apparatus information, or the time information, and (ii) a content of the operation.

12. The electrical apparatus according to claim 1, further comprising:
an operation receiver configured to receive an operation of the electrical apparatus from a user, wherein
after acquisition of the request by the request acquirer, the power controller reduces the power consumed by the power consumer upon (i) receipt of the operation by the operation receiver, or (ii) elapse of a predetermined period after the acquisition of the request by the request acquirer.

13. The electrical apparatus according to claim 1, further comprising:
a notifier configured to provide, upon a reduction of the power by the power controller, notification of the reduction of the power.

14. The electrical apparatus according to claim 13, wherein the notifier provides, upon the reduction of the power by the power controller, notification of at least one of (i) whether a reduction amount of the power reached a limit or (ii) whether the reduction of the power is prioritized over a user operation of the electrical apparatus.

15. The electrical apparatus according to claim 13, wherein the notifier provides, upon the reduction of the power by the power controller, notification of an operating state of the electrical apparatus after the reduction of the power.

16. The electrical apparatus according to claim 13, wherein the notifier provides, upon the reduction of the power by the power controller, notification that distinguishes between an operation selectable by a user and an operation non-selectable by the user.

17. A power consumption reduction system, comprising:
the electrical apparatus according to claim 1; and
a control device comprising a request transmitter configured to transmit the request to the electrical apparatus.

18. The power consumption reduction system according to claim 17, wherein
the control device further comprises a measurement value acquirer configured to acquire a measurement value of power supplied from a commercial power system to a power consumption site in which the electrical apparatus is disposed, and
when the measurement value is greater than a permissible value, the request transmitter transmits the request to the electrical apparatus.

19. A communication adapter for electrically connecting with an electrical apparatus including a power consumer to consume power, the communication adapter comprising:
a request acquirer configured to acquire a request for reducing the power consumed by the power consumer;
a control range adjuster configured to adjust a control range of the power consumed by the power consumer based on at least one of environmental information regarding an ambient environment of the electrical apparatus, apparatus information regarding the electrical apparatus, or time information; and
a power controller configured to control, upon acquisition of the request by the request acquirer, the power consumer based on at least one of the environmental information, the apparatus information, or the time information, to reduce the power consumed by the power consumer to be within the control range adjusted by the control range adjuster.

20. A power consumption reduction method for reduction of power consumed by an electrical apparatus, comprising:
acquiring a request for reducing the power;
adjusting a control range of the power consumed by the electrical apparatus based on at least one of environmental information regarding an ambient environment of the electrical apparatus, apparatus information regarding the electrical apparatus, or time information; and
upon acquiring of the request, controlling the electrical apparatus based on at least one of the environmental information, the apparatus information, or the time information, to reduce the power consumed by the electrical apparatus to be within the control range.
